(19) United States
(12) Patent Application Publication
(10) Pub. No.: US 2004/0006528 A1
(43) Pub. Date: Jan. 8, 2004

(54) Method and system for improving the liquidity of transactions for PM pools and auctions

(76) Inventor: Ka Shun Kevin Fung, Hong Kong (HK)

Correspondence Address: SAWYER LAW GROUP LLP, P O BOX 51418, PALO ALTO, CA, 94303, US

(21) Appl. No.: 10/600,137

(22) Filed: Jun. 20, 2003

Related U.S. Application Data
(60) Provisional application No. 60/389,956, filed on Jun. 20, 2002.

(51) Int. Cl. G06F 17/60

(52) U.S. Cl. 705/37

(57) ABSTRACT

A method and system for improving liquidity of transactions for a first plurality of contracts for a pari-mutuel (PM) pool or auction is disclosed. In one aspect, the method and system include providing a complete set including a second plurality of contracts. The complete set guarantees at least an initial settlement value at at least one particular time. The complete set also corresponds to a settlement value, which is determined based upon the initial settlement value. In another aspect, the method and system include obtaining a plurality of orders corresponding to a plurality of contracts. In this aspect the method and system include performing a price auction on the plurality of orders and then performing a quantity auction to determine a quantity of the plurality of orders which are qualified.

### CROSS-REFERENCE TO RELATED APPLICATIONS

This application is claiming under 35 USC 119(e) the benefit of provisional patent application serial No. 60/389,956 filed on Jun. 20, 2002.

The present application is related to co-pending U.S. patent application Ser. No. (2626P), entitled “METHOD AND SYSTEM FOR IMPROVING THE LIQUIDITY OF TRANSACTIONS” filed on Jun. 19, 2003. The present application is also related to co-pending U.S. patent application Ser. No. (2700P), entitled “METHOD AND SYSTEM FOR UTILIZING A SPECIAL PURPOSE VEHICLE FOR IMPROVING THE LIQUIDITY OF TRANSACTIONS” filed on Jun. 19, 2003. The present application is also related to co-pending U.S. patent application Ser. No. (2701P), entitled “METHOD AND SYSTEM FOR MANAGING CREDIT-RELATED AND EXCHANGE RATE-RELATED RISK” filed on Jun. 19, 2003.

### FIELD OF THE INVENTION

The present invention relates to financial instruments, and more particularly to a method and system for improving the liquidity of transactions, preferably using a computer system.

### BACKGROUND OF THE INVENTION

A variety of financial instruments, or contracts, are currently traded in many different markets. These contracts could take a variety of forms and be related to a variety of activities. For example, the contracts could range from options and futures to betting. Participants in the markets place bids (offers to buy contract(s)) and offers (offers to sell contract(s)). Each offer and bid has a price limit associated. The participants in the market could include individual participants, financial intermediaries, and market makers, such as brokerage houses or banks. Furthermore, the buyers and sellers could be short or long. For example, a long seller is a seller already having a position in the market and holding the contract for which the seller made an offer. A short seller is a seller who does not yet have ownership of the contract being offered for short sale. Similarly, a buyer may be making a bid to cover a contract previously offered for sale. In the case of betting, in purchasing a contract, a buyer may simply be making a bet. Similarly, a seller of a contract in betting is typically a bookmaker. Systems such as www.betfair.com and www.intrade.com allow customers to purchase multiple contracts (bets) as a set. Thus, relationships between buyers, sellers, individual participants and market makers may be complex. Furthermore, unnecessary uncertainty may be created in these relationships, which indirectly increases trading costs. In addition, the market in which the participants act could be a traditional exchange, a bookmaking enterprise such as a casino, or other similar market.

Typically, the interaction between the market participants can take place via three conventional structures: conventional order matching, conventional market making, and conventional auctions. In conventional order matching, bids and offers are centralized, typically in an exchange. Individual participants can then buy or sell until an equilibrium for a particular contract is reached. Typically, the exchange takes no risk in the market. In conventional market making, a market maker takes a position opposite to other market participants. Thus, a market maker may sell or buy contracts to other market participants. In conventional auctions, a contract is typically offered for sale to any market participant. Conventional auctions can take a variety of forms. In certain conventional auctions, the contract is initially offered at a high price. The price is progressively lowered until a bid is made and the contract is sold. In conventional Dutch auctions, the lowest price necessary to sell the entire lot of contracts becomes the price at which the contracts are sold.

Similar to conventional auctions are pari-mutuel (PM) pools. In a PM pool, market participants can choose to put money into a pool up until a cutoff time. When putting money into the pool, the market participants select from a number of outcomes. Placing money on a particular outcome can be considered to be buying a PM contract. Thus, as used herein, a PM contract is considered to be an amount of money placed on a particular outcome available for selection in the PM pool. After the cutoff time, the return for each outcome is determined based upon the amount of money corresponding to that outcome and the total amount of money in the pool. The more money placed on a particular outcome, the lower the rate of return. The PM contracts mature when one of the outcomes actually comes to pass, and the market participants who selected the winning outcome split the pool.

For example, suppose a PM pool is organized for an event having four possible outcomes. Market participants are allowed to purchase PM contracts for the four outcomes, z1, z2, z3, and z4. For example, market participants might be betting on the winner of a race having four entrants. Market participants are allowed to purchase PM contracts for z 1, z2, z3, and z4 until the cutoff time. After cut-off time, the organizer records the following money put on by players in aggregate: z1: 1,234, 876 (6 percent); z2: 6,894,365 (thirty-one percent); z3: 7,678,775 (thirty-five percent); z4: 6,256,767 (twenty-eight percent). The total pool is 22,064,783. The PM payout ratio (PMPR) for each contract is given by the total pool divided by the money for the contract. Thus, the PMPR for z1 is 17.87 (22,064,793/1,234,876). The PMPR for z2 is 3.2, the PMPR for z3 is 2.87, and the PMPR for z4 is 3.53.

Furthermore, the organizer of the PM pool may wish to have a certain profit for each pool. Thus, for example, an organizer may desire to have a profit of fifteen percent of the pool. This profit will reduce the money available and, therefore, lower the PMPR for each outcome. For example, for the above example, and a profit of fifteen percent, the pool would be reduced to 18,755066 and the organizer would receive 3,309,717. Consequently, the PMPR ratios would be 15.19, 2.72, 2.44, and 3.00 for z1, z2, z3, and z4, respectively.

Regardless of the structures used, the market can be viewed as coming to equilibrium when the prices for all bids for a particular contract are less than prices for all offers for the contract. In other words, no bid is high enough (or conversely no offer is low enough) for a transaction to take place and the contract to be sold. As a result, no more transactions will take place for the contract until a new bid and/or new offer that bridge the gap between the bids and offers is made.

Although conventional structures allow transaction to take place and for the market to come to equilibrium, conventional methods for allowing transactions have drawbacks. First, the conventional structures may not result in a high degree of liquidity. Typically, liquidity can be measured in three ways: bid/offer spread, volume and price discovery. The bid/offer spread is an instantaneous measurement of liquidity. The bid/offer spread is the difference between the highest bid and lowest offer for a particular contract at a particular instant in time. The higher the bid offer spread, the lower the liquidity because the less likely that a market participant will be able to sell or buy the contract. The liquidity can be measured by the time required to have an order for a contract filled or the volume of transactions for a given unit of time. The shorter the time required to fill an order and the higher the volume of transactions, the greater the liquidity and the easier it would be for a market participant to enter or leave the market. Price discovery is the ability to discover the true price of a contract in the market that has reached equilibrium. The easier it is to discover the price of a contract, the higher the liquidity. Thus, conventional structures such as order matching may result in a higher bid/offer spread, a lower volume of transactions, and more difficulty in determining the actual price of the contracts.

A high liquidity is desirable. A higher liquidity allows the market participants to move in and out of the market more easily. In addition, exchanges desire a high liquidity because exchanges typically obtain a profit based upon the number of transactions carried out. The higher the liquidity is, the higher the number of transactions and the greater the profit of the exchange. Market makers desire a higher liquidity because a high liquidity translates to a higher number of transactions, lower risk for the market maker and a lower cost of borrowing capital for the market maker. Thus, it would be desirable for a higher liquidity in the market place than may be available using the conventional structures for performing transactions.

In addition, the conventional structures of conventional order matching, market making and auctions performed in the conventional manner described above have other drawbacks. Conventional order matching often does not function well when there is an insufficient number of sellers that actually have contract(s) to sell, as opposed to a short seller. As a result, there will be lowered liquidity. In some situations, conventional market makers may actually have an incentive to reduce the competitive nature of the marketplace because the market maker may act to their own advantage, rather than to the advantage of the market as a whole. Conventional auctions take time to set up and identify winner(s).

Accordingly, what is needed is a system and method for addressing the drawbacks of conventional mechanism for allowing transaction to occur. The present invention addresses such a need.

### SUMMARY OF THE INVENTION

The present invention provides a method and system for improving liquidity of transactions for a first plurality of contracts for a pari-mutuel (PM) pool or auction. In one aspect, the method and system comprise providing a complete set including a second plurality of contracts. The second plurality of contracts corresponds to the first plurality of contracts. The complete set guarantees at least an initial settlement value at at least one particular time. The complete set also corresponds to a settlement value that is determined based upon the initial settlement value. In another aspect, the method and system include obtaining a plurality of orders corresponding to a plurality of contracts. In this aspect the method and system include performing a price auction on the plurality of orders and then performing a quantity auction to determine a quantity of the plurality of orders which are qualified.

According to the system and method disclosed herein, the present invention provides improved liquidity, improves the management of credit related risks and allows greater flexibility in transactions related to PM pools and auctions.

### BRIEF DESCRIPTION OF THE DRAWINGS

FIG. 1A is a high level flow chart depicting one embodiment of a method in accordance with the present invention for improving the liquidity of transactions in situations such as a PM pool and/or auction.

FIG. 1B is a block diagram of the interaction of one embodiment of a special purpose vehicle in accordance with the present invention interacting with market participants.

FIG. 1C is a block diagram of one embodiment of a computer system that can be used for the method in accordance with the present invention.

FIG. 2A is a high level flow chart of one embodiment of a method in accordance with the present invention for converting the PM pool contracts to contracts in a complete set.

FIG. 2B is a high level flow chart of a second embodiment of a method in accordance with the present invention for converting the PM pool contracts to contracts in a complete set.

FIG. 3A is a high level flow chart depicting a second embodiment of a method in accordance with the present invention for improving the liquidity of transactions in situations such as a PM pool and/or auction.

FIG. 3B is a more detailed flow chart of one embodiment of a method and system in accordance with the present invention for converting PM contracts or auctions contracts into a complete set of contracts.

FIG. 4A is a high level flow chart of one embodiment of a method for forming a PM pool when there are price limits and noncombination orders for the PM pool contracts.

FIG. 4B is a high level flow chart of a one embodiment of a method for forming a PM pool when there are price limits, buy and sell orders for the PM pool contracts.

FIG. 4C is a high level flow chart of a second embodiment of a method for forming a PM pool when there are price limits, buy and sell orders for the PM pool contracts.

FIG. 4D is a high level flow chart of a third embodiment of a method for forming a PM pool using last mileage shorting when there are price limits, buy and sell orders for the PM pool contracts.

FIG. 5A is a high level flow chart of a first embodiment of a method for finalizing an auction when there are price limits, buy and sell orders for the auction contracts.

FIG. 5B is a high level flow chart of one embodiment of a method for performing a quantity auction.

FIG. 5C is a graph depicting one embodiment of a quantity auction.

FIG. 5D is a high level flow chart of another embodiment of a method for performing a quantity auction.

FIG. 6 depicts residual contracts after a quantity auction is performed for a continuous variable.

FIG. 7 depicts a high level flow chart of a method for using allocation policy to treat Non-uniform-quantity or Uniform-quantity combination orders.

FIG. 8 depicts a preferred embodiment of a method for providing a better estimation of contract orders in term of dummy investable amounts.

FIG. 9A depicts one embodiment of a method for utilizing static allocation policy for a price auction.

FIG. 9B depicts one embodiment of a method for using market driven allocation policy for a price auction.

FIG. 9C depicts one embodiment of a method for determining the market driven allocation policy based upon the highest single unit PMPR.

FIG. 9D depicts one embodiment of a method for determining the market driven allocation policy based upon the lowest single unit PMPR.

FIG. 9E depicts one embodiment of a method for determining the market driven allocation policy based upon the dummy investable amounts.

FIGS. 10A, 10B, 10C, and 10D are graphs depicting the return for a long call, a short call, a long put, and a short put, respectively.

FIGS. 10E and 10F depict a call spread between sixty and eighty and a put spread between three hundred and four hundred, respectively.

FIG. 10G depicts one complete contract of a complete set having a vertical boundary.

FIGS. 10H and 10I depict one embodiment of how a call and put spread are replicated using contracts in a complete set.

FIG. 11 is a flow chart depicting one embodiment of a method for implementing a diagonal allocation policy

### DETAILED DESCRIPTION OF THE INVENTION

The present invention relates to an improvement in transactions involving financial instruments. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present application is related to co-pending U.S. patent application Ser. No. (2626P), entitled “METHOD AND SYSTEM FOR IMPROVING THE LIQUIDITY OF TRANSACTIONS” (first co-pending application) filed on Jun. 19, 2003. Applicant hereby incorporates by reference the above-identified co-pending patent application.

Using the method and system described in the above-identified co-pending application, liquidity of transactions is improved. The method and system preferably deals with the kinds of contracts described above. Each contract in the complete set matures upon a particular event or events and might be traded individually. The contracts could be concerning a wide variety of subjects. Such contracts include but are not limited to options, futures, contracts based on PM pools, contracts based on auction orders and bets. In a preferred embodiment, each contract is discrete. A discrete contract is one which, upon maturing, either wins or loses. Thus, the payment a holder of the contract is due upon maturing is either a positive sum (for a winning contract) or zero (for a losing contract). For example, if the contract is a bet on a particular sporting event, upon expiration of the sporting event, a holder of the contract has either won or lost. Thus, the outcome for such a contract can be considered to be a yes/no or true/false type of outcome. However, in another embodiment the payment amount to which the holder of the contract is entitled may vary. For example, one such contract may entitle its holder to be paid a variable amount conditional upon whether the actual price of the stock is higher than a predetermined price level (the strike price of the call option) at a particular time. The particular time can be considered to be the event upon which the contract matures. If, at the particular time, the stock has an actual price that is higher than the strike price, then the contract wins. However, the total amount that the holder is due depends upon the difference between the actual price of the stock and the strike price of the option. Moreover, such variable amount is usually subject to a predetermined “ceiling” (the capped amount for call spread or capped call option).

The method and system described in the above-identified co-pending application define a complete set of contracts including a plurality of contracts. The complete set guarantees at least an initial settlement value at at least one particular time. The complete set also corresponds to a settlement value that is determined based upon the initial settlement value. In a preferred embodiment, the settlement value of a complete set is determined based upon the initial settlement value and an interest rate effect, if necessary. Thus, the settlement value is preferably the initial settlement value with the time value of money accounted for, if desired. Consequently, the complete set can be viewed as fulfilling the condition that the complete set corresponds to a constant total sum (CTS) corresponding to the settlement value. In a preferred embodiment, the contracts in the complete set are not only discrete but also mutually exclusive and collectively exhaustive. Because the contracts are mutually exclusive, if one contract in the complete set is a winning contract, no other contract in the complete set will be a winning contract. Because the contracts are collectively exhaustive, all outcomes are represented by the complete set of contracts. However, the contracts in the complete set need not be mutually exclusive and/or collectively exhaustive. In order to define the complete set, the method and system described in the above-identified co-pending application monitor the marketplace or exchange to determine candidates for the complete set. For example, for stock options, candidates for the complete set might include a put spread and a call spread for a particular stock. If the complete set of contracts is based upon sporting event(s), candidates for the complete set might include the outcome(s) of the sporting events. If the contracts are for a commodity, then candidates for the complete set might include price ranges for the commodity. Based on the candidates found, the complete set can be determined.

In a preferred embodiment, the settlement value for the complete set is guaranteed regardless of when the complete set is exchanged and regardless of the price of each contract. In addition, the settlement value is preferably guaranteed regardless of the occurrence of the particular event(s) upon which the contracts' maturing depends. In one embodiment, the complete set can be exchanged for the settlement value at any time. In another embodiment, the settlement value can only be exchanged upon maturity of the contracts (or when the contracts do not mature). Thus, the complete set corresponds to the settlement value regardless of the outcome of the individual contracts or whether a particular contract is deemed to win. In addition, a holder of the complete set is preferably entitled to the settlement value in exchange for the complete set regardless of the outcome of the individual contracts or whether a particular contract is deemed to win. Furthermore, because the settlement value is preferably guaranteed independent of the occurrence of the event(s) upon which maturation of the contracts depends, the settlement value is preferably guaranteed even in the event that none of the contracts in the complete set is deemed to be a winner. This settlement value is determined and, except for the constant time value of money described below, can be considered to be constant. Thus, the complete set of contracts can be considered to be equivalent to a constant total sum known as the settlement value.

The settlement value can be determined in a variety of ways, typically based upon the price level of the underlying variable that characterizes the possible outcome(s) of the contracts in the complete set at the time the complete set is defined. Thus, the market conditions are preferably considered in determining the settlement value. In one embodiment, the settlement value is related to the tick value of the underlying variable. For example, if the complete set of contracts relates to the price of a commodity, such as gold, the price level is preferably based upon the price of gold and, preferably, the tick value (or an integral multiple of the tick value) of gold.

In a preferred embodiment, the settlement value may be adjusted to account for an interest rate effect, and ensure that the time value of the settlement value is constant. Stated differently, an adjustment in present value may be made to ensure that the “time value” of the settlement value remains constant over time. Consequently, where the settlement value is in money, such as money paid by buyer(s) in transaction(s) occurring in a typical stock exchange that is non-interest-bearing to the buyer(s) concerned, (as opposed to another instrument having a value that automatically adjusts for the interest rate, such as money paid by buyers in transactions occurred in a typical futures exchange that is interest-bearing to buyers concerned), the settlement value is adjusted. In a preferred embodiment, the settlement value is adjusted based upon the initial settlement value determined at the time the complete set is defined. This initial settlement value is realized at a predetermined time, typically when the contract(s) mature due to the occurrence of the corresponding event(s). The settlement value is determined based upon the initial settlement value, the time between the exchange of the complete set and the predetermined time at which the initial settlement value would be realized, and the interest rate (which might vary) over that time period. In other words, the settlement value at a particular time can be considered to be the initial settlement value discounted to the particular time. In such a case, monies in custody are preferably deposited in an interest bearing account in order to ensure the constant time value of the settlement value.

Each contract in the complete set preferably matures upon the same event(s) occurring. However, nothing prevents the contracts from maturing upon different events. The contracts in the complete set may relate to a particular range of a variable. In such a case, the winning contract(s) at the boundaries between ranges are determined when the complete set is defined. For example, each contract may be for a return if the price of a particular stock is within a range. In some complete sets, only one winner would exist at a boundary. In other complete sets, multiple contracts could be determined to be the winner at the boundary, with the winnings split in a particular fashion. In addition, in a preferred embodiment, the initial settlement value corresponds to the contracts in the complete set maturing. However, nothing prevents the at least one particular time and, therefore, the initial settlement value from corresponding to other times.

In the method and system described in the above-identified co-pending application, the complete set preferably corresponds to the settlement value regardless of whether the particular event(s) occur for any of the plurality of contracts and regardless of the price for each of the contracts in the complete set. Preferably, market participant(s) are also allowed to obtain the complete set of contracts in exchange for the settlement value and/or the initial settlement value. Consequently, the condition required to be met in order to obtain the settlement value is that the market participant(s) hold (or short) the complete set. Although a single market participant can hold/short the complete set, in a preferred embodiment multiple market participants can form a group. As long as the group holds the complete set, the group can exchange the complete set for the settlement value. The settlement value could be provided in cash. However, in alternate embodiments, cash need not be used. For example, the settlement value can be paid in goods or a negotiable instrument particular to the exchange in which the transaction is made. Payment in such a negotiable instrument would secure greater loyalty of the market participant to the exchange because the settlement value could only be used in transactions in the exchange. In addition, profits for the exchange could improve because of the increased number of transactions.

Using the method and system described in the first co-pending application, liquidity can be improved beyond the equilibrium established using conventional mechanisms. For example, equilibrium may be established in a conventional manner. As a result, all bids would be less than all offers for the contracts in a complete set. However, the sum of the bids for the contracts in the complete set may be greater than the settlement value. In such a case, a market participant or other entity may obtain the complete set in exchange for the settlement value. The contracts in the complete set could then be sold individually to each bidder to obtain a profit. Similarly, if the sum of the offers for the contracts in a complete set is less than the settlement value, then a market participant or other entity would use the offers to individually purchase the contracts. The complete set could then be exchanged for the settlement value and a profit obtained. As a result, more transactions would take place. Liquidity is, therefore, improved.

The method and system described in the first co-pending application can also be extended to provide additional benefits, particularly using a special purpose vehicle (SPV), which is also at least partially described in the first co-pending patent application. The SPV described in the first co-pending patent application performs a variety of functions. The SPV can buy and sell one or more of the contracts in the complete set, including the complete set itself. The functions of the SPV can be extended to provide further benefits.

The present application is also related to co-pending U.S. patent application Ser. No. (2700P), entitled “METHOD AND SYSTEM FOR UTILIZING A SPECIAL PURPOSE VEHICLE FOR IMPROVING THE LIQUIDITY OF TRANSACTIONS” (“Second Co-pending Application) filed on Jun. 19, 2003. Applicant hereby incorporates by reference the above-identified co-pending patent application.

The second co-pending application describes in further detail a special purpose vehicle (SPV) that can use the method and system of the first co-pending application. The second co-pending application also describes advantages of utilizing the SPV. The SPV described in the above-identified co-pending patent applications performs a variety of functions. The SPV can buy and sell one or more of the contracts in the complete set, including the complete set itself. The SPV can make orders conditioned upon, among other factors, a particular trade being made. The SPV-can also determine when it is profitable to individually buy and sell contracts, exchange the complete set for the settlement value, or exchange the settlement value for the complete set. For example, the SPV might determine that it is profitable to individually buy contracts in the complete set when the sum of the offer prices is less than or equal to the settlement value. The SPV might also determine that it is profitable to individually buy contracts in the complete set when the sum of the offer prices is slightly greater than the settlement value. The SPV might make this determination when the SPV is run by the exchange because the exchange receives payment on trades occurring. Furthermore, the SPV can interact with an entity such as an exchange window that allows the complete set of contracts to be exchanged for the settlement value and vice versa. Note that, as described above with respect to the buying and selling of contracts, exchanging the complete set of contracts for the settlement value and vice versa could be considered to be shorting or longing the complete set. Because of the SPV, liquidity can be improved, risk can be better managed, and other benefits achieved.

Although the methods, systems, and computer-readable media described in the first and second co-pending applications function well for their intended purpose, they can also function in other situations. In particular, PM pools and auctions could also benefit from the method and system described in the first and second co-pending applications. In addition to the PM pool described above, another analogous PM pool may be desired. For example, there may be market participants who wish to join the original PM pool described above, but who face obstacles to joining. Such market participants may be denied entry by the original organizer of the original PM pool, may face tax or regulatory barriers, there may be currency control of the original organizer's country that presents a barrier, or the market participants may simply be searching for a better price than offered in the original PM pool. Furthermore, another organizer, termed a copycat herein, may desire to create a PM pool to obtain a profit similar to the fifteen percent obtained by the original organizer in the example above. The copycat may even be able to run the PM pool at a lower profit margin, for example seven percent instead of fifteen.

Although a PM pool based on the original PM pool may be desirable for market participants and copycats, one of ordinary skill in the art will readily recognize that there are barriers to formation of such a PM pool. The original PM pool is well recognized and established. Moreover, the original organizer has the reputation of managing the original PM pool and providing the PMPR ratio. Many of the market participants who face barriers to entry into the original PM pool wish to participate in a PM pool having a PMPR identical to the original pool.

In order to entice market participants to participate in the copycat's PM pool, the copycat can offer market participants the opportunity to purchase PM pool contracts at a discounted price. Further, the copycat may provide the same PMPR as the original organizer. Consequently, the market participants holding a winning contract may have a higher effective PMPR ratio. For example, in the example discussed above, the copycat may charge eighty percent of the cost of purchasing a PM pool contract. In the example above, the PMPR for z1 is 15.19 when the original organizer takes fifteen percent of the pool. When a contract for z1 is discounted by twenty percent, $0.80 in the copycat's pool would be worth $1.00 in the original PM pool. Thus, the effective PMPR for z1 would be 18.9875 (15.19/.8). In addition, the copycat often accepts a smaller profit margin than the original organizer. For example, the copycat might take only five or seven percent of the pool, as opposed to the fifteen percent of the original organizer in the example above. Thus, a copycat can organize a PM pool, enticing participants with a higher effective PMPR, while obtaining some profit based on the copycat's PM Pool.

Although a copycat can organize a PM pool that pays out based upon the PMPR of the original PM pool, one of ordinary skill in the art will readily recognize that there are risks. In particular, there is no guarantee that the makeup of the PM pool is the same as the original PM pool. For example, there may be many more buyers of z1 in the PM pool (of the copycat) than in the original PM pool. If z1 is the winning contract, then many more holders of z1 may have to be paid than in the original PM pool. As a result, the copycat may not be able to obtain the profit desired, and may even lose money.

The present invention provides a method and system for improving liquidity of transactions for a first plurality of contracts for a PM pool or auction. In one aspect, the method and system include providing a complete set including a second plurality of contracts. The second plurality of contracts corresponds to the first plurality of contracts. The complete set guarantees at least an initial settlement value at at least one particular time. The complete set also corresponds to a settlement value that is determined based upon the initial settlement value. In another aspect, the method and system include obtaining a plurality of orders corresponding to a plurality of contracts. In this aspect the method and system include performing a price auction on the plurality of orders and then performing a quantity auction to determine a quantity of the plurality of orders which are qualified.

The present invention will be described in terms of a particular financial instruments and particular markets or exchanges. However, one of ordinary skill in the art will readily recognize that this method and system will operate effectively for other financial instruments and other market places. The present invention is also described in terms of particular components having certain features. However, one of ordinary skill in the art will readily recognize that the present invention is consistent with additional components and/or different or additional features. Furthermore, the present invention is described in the context of a single special purpose vehicle interacting with individual market participants. However, one of ordinary skill in the art will readily recognize that the method and system are consistent with multiple special purpose vehicles and/or multiple market participants. Furthermore, the present invention is described in the context of buying and selling. One of ordinary skill in the art will readily recognize that buying and selling can include shorting and/or longing.

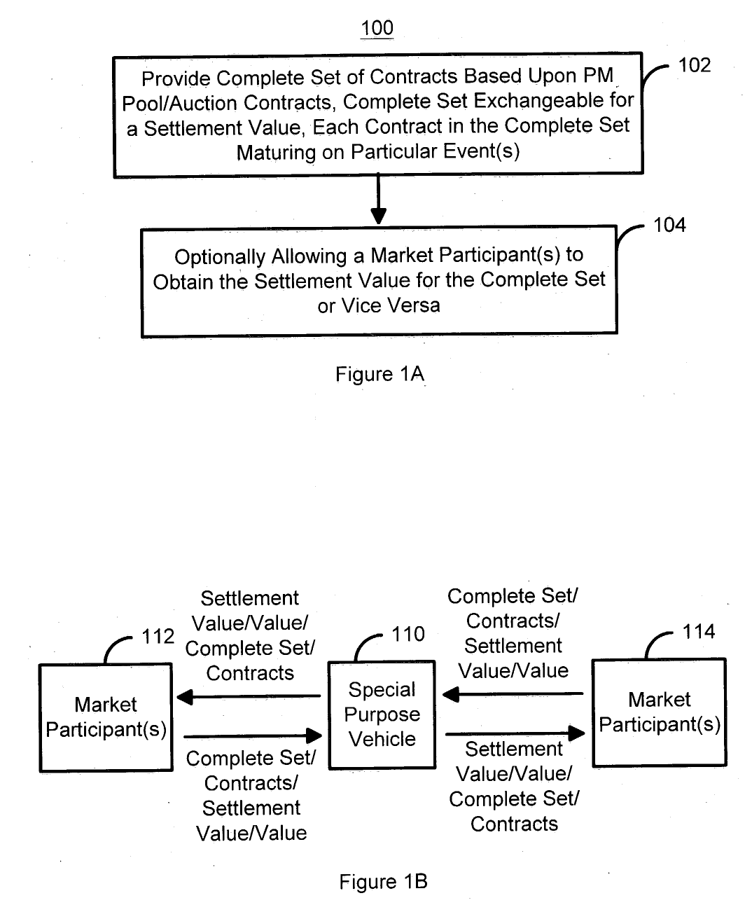

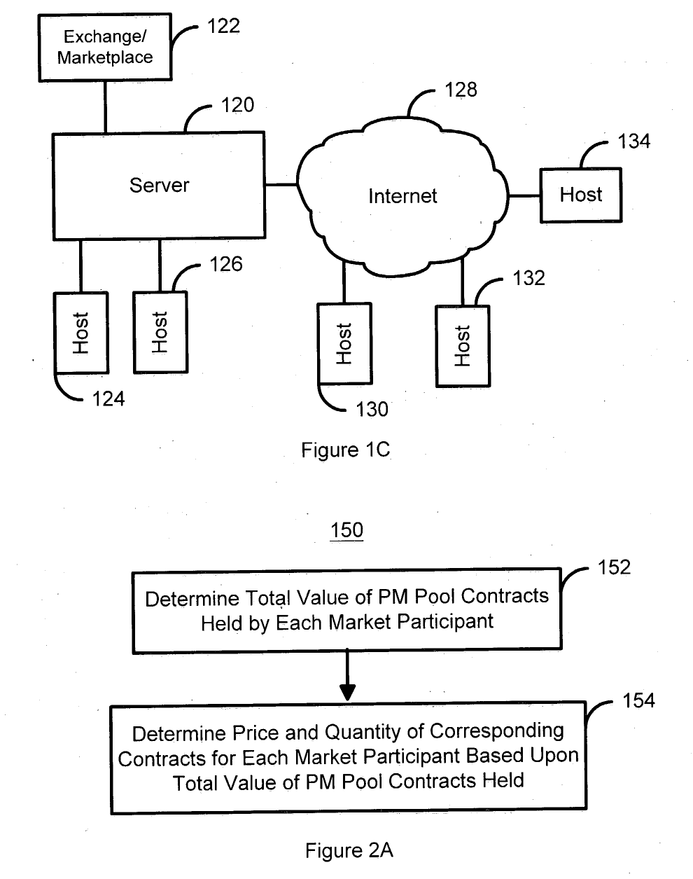

To more particularly illustrate the method and system in accordance with the present invention, refer now to FIG. 1A, depicting a high-level flow chart of one embodiment of a method 100 in accordance with the present invention for improving the liquidity of transactions in situations such as a PM pool and/or auction. In a preferred embodiment, the method 100 is performed at least in part by software used by an exchange, bookmaker, or other financial system or market participant. However, nothing prevents the method 100 from being implemented in another fashion by another entity. The method 100 preferably deals with the kinds of contracts described above with respect to the above-identified co-pending patent application. Consequently, the method 100 preferably includes but is not limited to certain aspects of the above-identified co-pending patent application.

The method 100 is used for a PM pool that is developed or an auction that has closed. In other words, the method 100 is used when the cutoff time for participation has been reached and before the contracts in the PM pool mature. In a preferred embodiment, the PM pool has been organized by a copycat and has a PMPR based upon an original PM pool. However, in an alternate embodiment, the method 100 can be used for a PM pool that sets its own PMPRs, such as the original PM pool. For auctions, the method 100 is preferably used after the auction settlement price has been set (i.e. after the auction has closed). Thus, the method 100 is used for a first plurality of contracts in the PM pool or auction. For simplicity, these contracts are termed PM pool contracts. Thus, as used herein, the term PM pool contract includes but is not limited to PM contracts and/or auction contracts. Note that the term PM pool contract is used even though the contracts may be for an auction or other analogous system. Consequently, as used herein, the term PM pool contract can be synonymous with other contracts, including but not limited to auctions. In the example above, the PM pool contracts would be the contracts for z1, z2, z3, and z4 in the PM pool. The method 100 is described in the context of a PM pool.

A complete set including a second plurality of contracts is provided based upon the PM pool contracts in the PM pool or auction, via step 102. Step 102 thus includes forming a complete set of (preferably) one each of the contracts in the auction or (preferably) one of each of the outcomes of the PM pool. However, step 102 performs additional conversions, discussed below. Each of the second plurality of contracts preferably matures upon at least one particular event occurring. Each of the PM pool contracts also matures upon the at least to one particular event occurring. Thus, the second plurality of contracts corresponds to the first plurality of contracts. The complete set corresponds to at least a settlement value and guarantees at least an initial settlement value upon the second plurality of contracts maturing. In the case of a PM pool, the complete set of contracts determined in step 102 is represented by the outcomes of the PM pool. As described above, the complete set defined in step 102 preferably includes one of each of the outcomes of the PM pool contracts. In the example above, the complete set would include Cz1+Cz2+Cz3+Cz4, where Cz1, Cz2, Cz3, and Cz4 correspond to the outcomes z1, z2, z3, and z4, respectively. In a preferred embodiment, step 102 is performed by an organizer or special purpose vehicle (SPV), described below. The settlement value at a particular time is preferably determined based upon the initial settlement value realized at a predetermined time and an interest rate effect. The initial settlement value is preferably the settlement value when the contract(s) in the complete set mature. Thus, after determining the complete set of contracts that correspond to the PM contracts, the SPV basically becomes a short seller of the contracts for each PM pool participant that is a holder of PM contracts.

At least one holder of the complete set is optionally allowed to obtain the settlement value for the complete set, or vice versa, regardless of whether the at least one particular event occurs for any of the second plurality of contracts, via step 104. Note that in the context of this application, holder(s) of contracts and/or the complete set includes market participant(s) that are shorting contracts and/or the complete set.

FIG. 1B is a block diagram of the interaction of one embodiment of a special purpose vehicle 110 in accordance with the present invention interacting with market participants 112 and 114. FIG. 1C is a block diagram of one embodiment of a computer system that can be used for the method in accordance with the present invention. The computer system preferably includes a server 120. The server 120 is connected to the Internet 128 and thus to hosts 130, 132 and 134. The server 120 can also communicate with hosts 125 and 126, as well as the exchange 122.

Thus, the contracts in the complete set can be offered for sale by the SPV 110 or participants of the PM pool or auction. As a result, the benefits described in the first and second co-pending applications can be realized. In particular, liquidity for the PM pool or auction contracts is improved. In particular, in the time between the closing of the PM pool or auction and the contracts maturing (in the example above, before it is determined whether z1, z2, z3, or z4 is the winning outcome), the contracts in the complete set can be traded individually or as part of a complete set. A market participant, SPV 110, or other entity may obtain the complete set in exchange for the settlement value. The contracts in the complete set could then be sold individually to bidders to obtain a profit. Similarly, if the sum of the offers for the contracts in a complete set is less than or equal to the settlement value, then a market participant, SPV 110 or other entity would use the offers to individually purchase the contracts. The complete set could then be exchanged for the settlement value and a profit obtained. As a result, more transactions would take place. Liquidity is, therefore, improved. In one embodiment, the complete set can be exchanged for the settlement value (e.g. the initial settlement value) only upon the contracts maturing. In another embodiment, the complete set can also be exchanged for the settlement value at other times.

The SPV 110 may also perform other functions. For example, the SPV 110 is allowed to secure trades when buying and/or selling at least one of the contracts in the complete set. This allows the SPV 110 to engage in batch trading of the contracts. The SPV 110 may also generate conditional orders to buy and/or sell contracts in the complete set. A conditional order is one in which the SPV will trade only if the condition(s) are fulfilled. In such a case, the price the SPV 110 offers to buy contracts at could be for a zero price. In addition, the SPV 110 allows market participants to short the contracts in the complete set. However, the SPV 110 may require that the market participant deposit a margin in such a case.

In addition, credit related risks can be better managed for the market participants wanting to engage in contracts related to the PM pool or auction. Because of the ability of the SPV to buy and/or sell contract(s) in complete set(s), and the definition of a complete set, the credit risk can be determined. In other words, the ability of the SPV to buy and/or sell contracts reduces the credit risk to a zero sum game. The credit risk is preferably a maximum credit risk. In a preferred embodiment, the risk can be determined by subtracting the price(s) of contract(s) from the payout if the contract wins upon maturity for contract(s). For a short sale, this difference would be the margin posted by the market participant short selling the contract. The market participant would preferably post the margin with the SPV. In such a case, the SPV is acting as a safe keeper for the margins until the winning contract is determined. In the case where the market participant is buying, the maximum risk can also be determined based upon the winning payout and the contract prices.

Because credit risk can be managed, a market participant can define a credit risk matrix of those individuals with whom the market participant wishes to trade. Moreover, credit swapping, credit netting and credit bridging can be achieved by market participants engaging in trading of the complete set. In credit netting, credit risks can be transferred between parties to release credit risks that would have been tied up until expiration of the contracts. For example, suppose market participants A, B, and C are trading contracts in the complete set. For example, suppose A wishes to buy a lot of a particular contract at a first price from B and sell a lot of the same contract to C at a second price. The credit could be netted so that C buys directly from B at the second price. B thus lends A the difference between the first price and the second price for the lot. Alternatively, C can buy from B at the first price. C then lends A the difference between the first and second prices.

In credit swapping, market participants that prefer to interact can be allowed to do so. The difference in the valuation in credit between the market participants can thus, be exploited. For example, suppose that A, B, C, and D are trading. In one transaction, A buys 1 lot of a contract at a first price from B. In another transaction C buys one lot of the contract at the first price from D. Suppose B prefers to trade with C rather than A. The credit can be swapped so that A can buy the lot from D, and C can buy the lot at from B.

In credit bridging, credit can effectively be extended to other participants. Suppose A, B, and C are market participants. B desired to buy a lot of a contract at a first price. C desires to sell a lot of the same contracts at a second price. Also assume that A can trade with and has a credit risk defined for both C and B. A can buy the contracts from C, and sell these contracts to B. In effect, B and C are trading together. Thus, using the method 100, risks can be better managed.

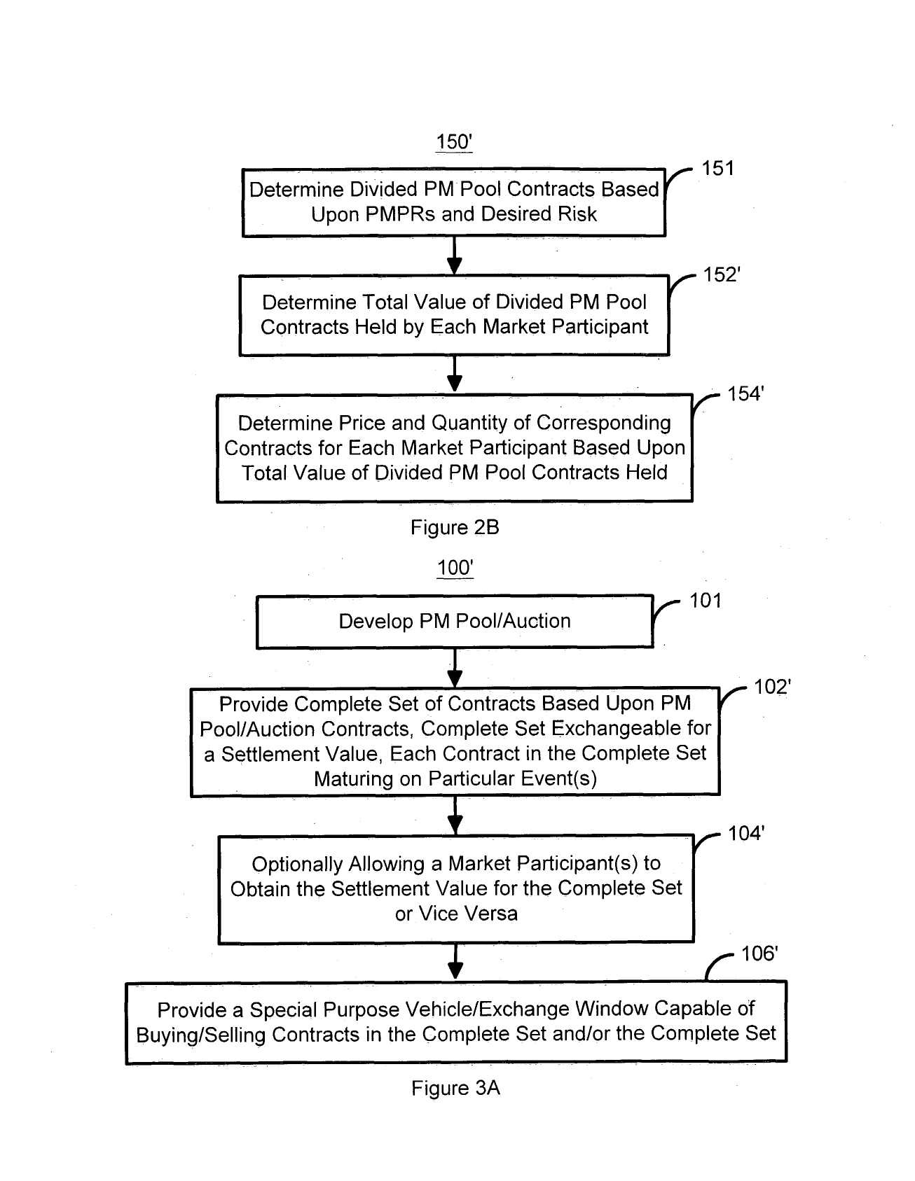

FIG. 2A is a high level flow chart of one embodiment of a method 150 in accordance with the present invention for converting the PM pool contracts to contracts in a complete set. The method 150 may be used to perform at least a portion of the step 102 in the method 100. The total value of the contracts in the complete set is the value of the PM pool. Also, note that the value of the PM pool can change. For example, the money in the PM pool may be deposited in an interest bearing account. Thus, the interest rate effect can be accounted for in this manner.

In order to convert the PM pool contracts into a complete set, the value and price of each contract in the complete set, as well as the settlement value, are determined in the method 150. The total value of all of the contracts corresponding to the complete set is equal to the total value of the PM pool. In addition, one contract type in the complete set corresponds to a contract in the PM pool. Thus, in the example above, with a fifteen percent profit, the total value of the complete sets being formed is 18,755,066. This is the money from the PM pool that is available for distribution. The total value of the PM pool contracts held by each market participant is determined, via step 152. In order to perform step 152, the following equation holds true for each holder of a particular type of PM pool contracts: PMPR*(number of PM contracts held)*(notional value of pm pool contracts)=total value of contracts in complete set to the holder. For example, in the example above, z1 has a PMPR of 15.19. A complete set would correspond to Cz1, Cz2, Cz3, and Cz4. Also assume that the notional for each PM pool contract is $1 and that the market participant holds one hundred contracts. Using the equation above, the value of the contracts in the complete set corresponding to the one hundred PM pool contracts is 15.19*100*($1)=$1519.

Based on this value, the price and quantity for each contract are determined, via step 154. Step 154 might then include determining that each contract corresponding to the PM pool contracts for z1 includes setting the individual price and quantity. In the example above, step 152 could include determining that the one hundred PM pool contracts corresponds to 1519 contracts in the complete set, each of which has a price of $1. Alternatively, step 152 could include determining that each contract Cz1 has a value of $15.19 and one hundred contracts can be provided to the holder of the PM pool contracts.

Thus, using the method 150, the PM pool contracts (e.g. contracts for a PM pool or auction) can be converted to contracts in a complete set. Although the method 150 functions well for its intended purpose, one of ordinary skill in the art will readily recognize that the organizer of the PM pool might wish to limit their risk. For example, in cases where short selling is allowed in formation of the PM pool, the PMPR can grow very large. In order to manage risk due to large PMPRs, the copycat or other organizer may establish price limits on the PMPRs.

Thus, the contracts in the PM pool or auction have been translated to a complete set of contracts. As a result, the benefits described in the first and second co-pending applications can be realized. In particular, liquidity for the PM pool or auctions contracts is improved. In particular, in the time between the closing of the PM pool or auction and the contracts maturing (in the example above, before it is determined whether z1, z2, z3, or z4 is the winning outcome), the contracts in the complete set can be traded individually or as part of a complete set. A market participant, SPV, or other entity may obtain the complete set in exchange for the settlement value. The contracts in the complete set could then be sold individually to bidders to obtain a profit. Similarly, if the sum of the offers for the contracts in a complete set is less than or equal to the settlement value, then a market participant, SPV or other entity would use the offers to individually purchase the contracts. The complete set could then be exchanged for the settlement value and a profit obtained. As a result, more transactions would take place. Liquidity is, therefore, improved.

FIG. 2B is a high level flow chart of a second embodiment of a method 150′ in accordance with the present invention for converting the PM pool contracts to contracts in a complete set. Divided PM contracts using price limits for the PMPRs are determined, via step 151. Step 151 includes determining the price limit(s) for each contract that is being divided. In the example above, a price limit, K, of 10 may be set for the PMPR for z1 in step 151. In such a case, the PM contracts for z1 become divided contracts. One set of divided PM pool contracts provides a return of up to a factor of 10 (i.e. the minimum of K and PMPR) for z1. The other set of divided contracts would provide a return of a factor of PMPR-K (e.g. 5.19). Together, the two divided PM pool contracts would form the PM contract that is not divided. This can be checked by determining the effective PMPR for the first divided PM pool contract (PMPR or K) and the effective PMPR of the remaining divided PM pool contract (PMPR-K). Thus, a single PM pool contract is divided into multiple contracts having a smaller PMPR. A market participant may then choose to buy some of the divided contracts. Because the PMPR is smaller, the divided contracts also preferably have a lower price. Thus, market participants can choose between different contracts. In addition, note that the contracts in the complete set can also be made divided contracts.

The total value of the divided PM pool contracts held by each market participant is determined, via step 152′. Step 152′ is analogous to step 152. In order to perform step 152′, the following equation holds true for each holder of a particular type of PM pool contracts: (return)*(number of PM contracts held)*(notional value of pm pool contracts)=total value of contracts in complete set to the holder. The return may be min[PMPR, K] or [PMPR-K], or may be further divided depending upon the number of times the particular PM pool contract is divided. Based on this value, the price and quantity for each contract in the complete set are determined, via step 154′. Step 154 is thus analogous to step 154.

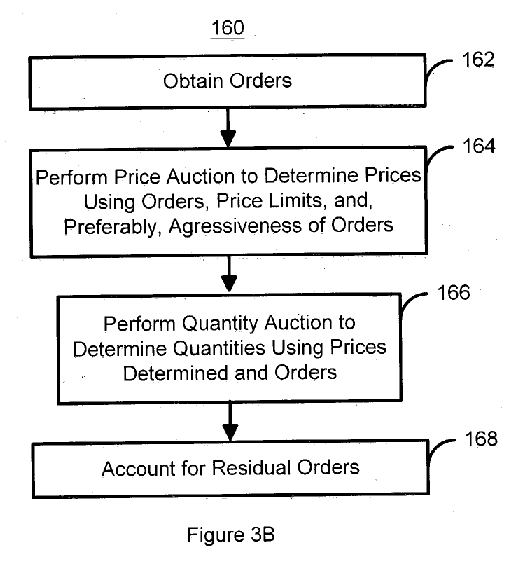

FIG. 3A is a high level flow chart depicting a second embodiment of a method in accordance 100′ with the present invention for improving the liquidity of transactions in situations such as a PM pool and/or auction. In a preferred embodiment, the method 100′ is performed at least in part by software used by an exchange, bookmaker, or other financial system or market participant. However, nothing prevents the method 100′ from being implemented in another fashion by another entity. The method 100′ preferably deals with the kinds of contracts described above with respect to the above-identified co-pending patent application. Consequently, the method 100′ preferably includes but is not limited to certain aspects and benefits of the above-identified co-pending patent application.

The PM pool or auction is developed and closed, as described below, via step 101. In a preferred embodiment, the PM pool has been organized by a copycat and has a PMPR based upon an original PM pool. However, in an alternate embodiment, the PM pool organizer can set its own PMPRs, such as the original PM pool. Step 101 includes setting the PM pool or auction such that the contracts are as desired for conversion to a complete set. In a preferred embodiment, step 101 includes iteratively determining which transactions will be included in the PM pool or auction. Methods for doing so are described below.

A complete set including a second plurality of contracts is provided based upon the contracts in the PM pool or auction, via step 102′. Step 102′ is analogous to the step 102. The methods 150 and 150′ described above can be used in performing step 102′. Each of the second plurality of contracts matures upon at least one particular event occurring. Each of the first plurality of contracts also preferably matures upon the at least one particular event occurring. Thus, the second plurality of contracts corresponds to the first plurality of contracts. The complete set corresponds to at least a settlement value and guarantees at least an initial settlement value upon the second plurality of contracts maturing. In a preferred embodiment, step 102′ includes translating the contracts for the PM pool or auction held by participants in the PM pool or auction to contracts of the complete set. In a preferred embodiment, step 102′ is performed by an organizer or special purpose vehicle SPV. Thus, the contracts in the complete set can be offered for sale by the SPV or participants of the PM pool or auction after the conclusion of step 102′. At least one holder of the complete set is preferably allowed to obtain the settlement value upon exchange of the complete set regardless of whether the at least one particular event occurs for any of the second plurality of contracts, via step 104′. Step 104′ is analogous to the step 104.

SPV can be used to buy and/or sell at least a portion of a complete set of contracts. In addition, the system which converts the PM pool contracts preferably also runs the SPV that buys or sells the contracts in the complete set. The SPV is capable of assembling complete sets of contracts and/or selling portions of the complete set or complete sets in their entirety. As a result, the SPV can obtain the settlement value in exchange for the complete set when desired. For example, the SPV might assemble the complete set when the sum of the prices of the individual contracts is less than or equal to the settlement value. Similarly, the SPV might sell the contracts individually when the sum of the bids is greater than or equal to the settlement value. Furthermore, the SPV might buy and/or sell contract(s) or complete set(s) when other conditions are fulfilled, depending upon the conditions input by the administrator of the SPV, such as the exchange. In making such conditional orders, the SPV could buy sell a contract at a zero price. Thus, like the method 100, the method 100′ can obtain the benefits of the first and second co-pending applications.

FIG. 3B depicts a more detailed flow chart of one embodiment of a method 160 for developing the PM pool or auction and converting the PM pool contracts (i.e. auction and/or PM contracts) to a complete set of contracts. Thus, the method 160 can be used in performing step 102 and steps 101 and 102′ of the methods 100 and 100′, as well as at least a portion of the methods 150 and 150′. In addition, the method 160 can also be used in other cases where a PM pool or auction orders are desired to be converted into contracts. Thus, the method 160 need not be used in forming a complete set of contracts. All of the orders are obtained, via step 162. Step 162 allows market participants to input their orders until the auction or PM pool is closed. The orders include the corresponding price limits and time chops (times at which the orders were made). A price auction is performed to determine the prices for the PM contracts and, therefore, the contracts in the complete set, via step 164. The price auction can utilize the price limits, quantities investment amounts, and/or time chops to determine the appropriate prices for the contracts in the complete set. In addition, for combination orders, the price auction performed in step 164 utilizes allocation policy, described below, to allocate portions of the price limits to the different PM contracts in the order. In a preferred embodiment, the price auction gives preference to aggressive orders. The aggressiveness of an order can be determined based upon the price (higher prices are more aggressive), quantity (larger quantities are more aggressive), time chop (earlier orders are more aggressive), other characteristics of the order, or some combination thereof. Consequently, step 164 preferably includes using some heuristic previously defined by the organizer (e.g. price), to determine the aggressiveness of orders and make determinations of price such that more aggressive orders have a higher impact on the price. In addition, the prices determined in step 164 are consistent with a single price for each basic unit (each single unit of each contract in the complete set).

A quantity auction is performed in step 166. The quantity auction determines the quantities of PM Pool contracts, and their corresponding orders, that are made part of the complete sets of contracts. Thus, the resultant of the quantity auction performed in step 166 is one or more complete sets of contracts. The contracts in each of the complete sets correspond to PM Pool contracts and, therefore, to the orders input to the price and quantity auctions. In a preferred embodiment, step 166 is performed after step 164 is completed. Performing the quantity auction after the price auction is distinct from conventional systems. Thus, in a preferred embodiment, the quantity auction is determined using the prices determined in the price auction as well as orders. The quantity auction determines the orders that are filled and the extent to which orders can be filled. In a preferred embodiment, the quantity auction gives preference to aggressive orders (as defined above). Thus, the quantity auction performed in step 166 attempts to include the aggressive orders as part of the complete sets of contracts being formed. In some instances, there may be orders which cannot be filled because the orders cannot be made part of a complete set. Such orders are termed residual contracts. Thus, any residual contracts which could not be included as part of the complete sets of contracts may be accounted for in step 168.

Using the method 160, therefore, orders, for example for an auction, can be converted to complete sets of contracts. In so doing, price and quantity of the PM contracts corresponding to the orders is determined. Thus, the benefits of the methods 100 and 100′ can be achieved. Furthermore, the method 160 allows for preference to be given to specific orders, preferably aggressive orders. Consequently, the organizer can reward the desired behavior of the market participants.

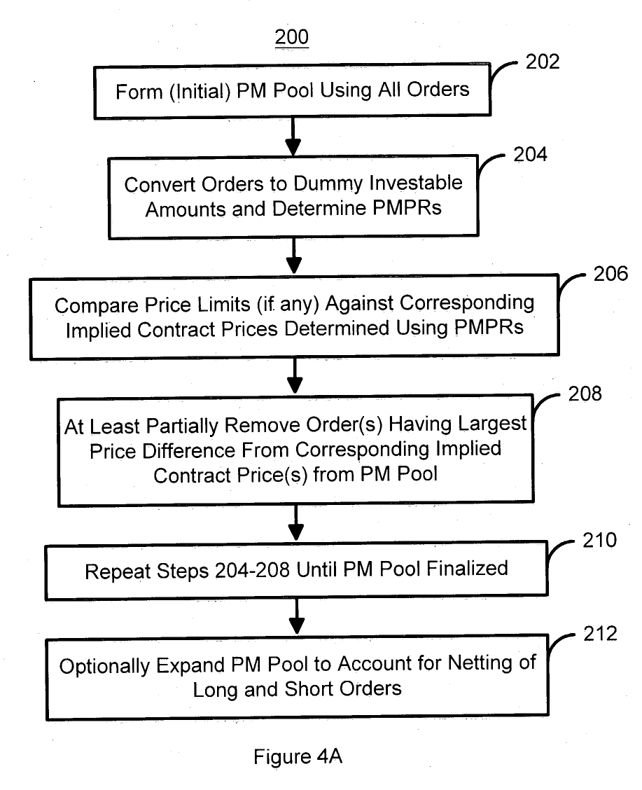

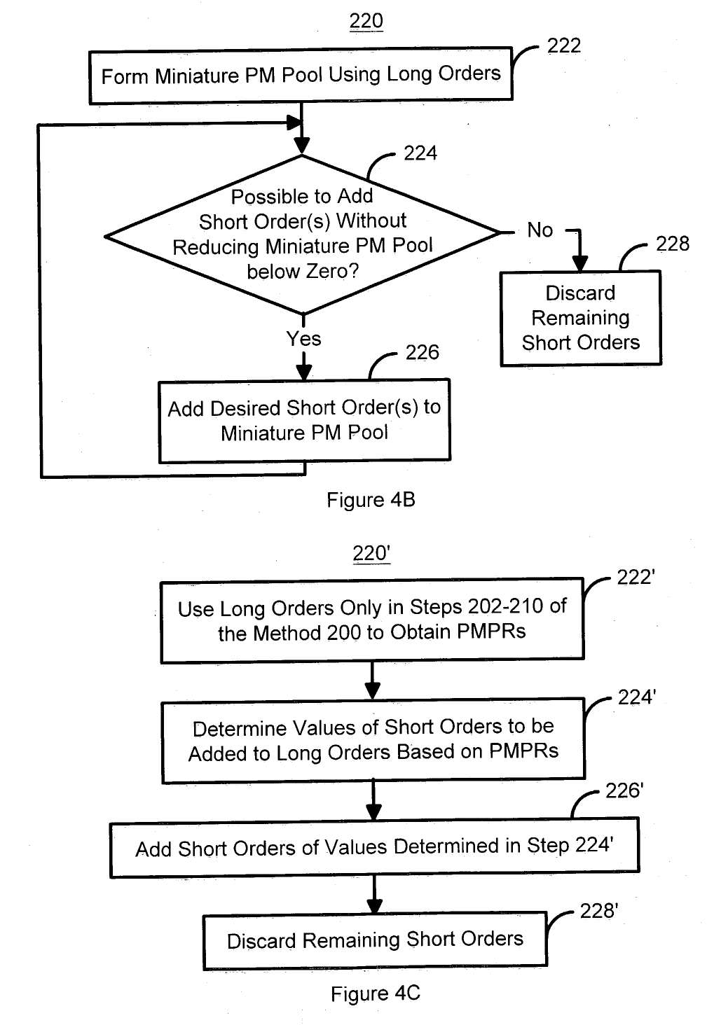

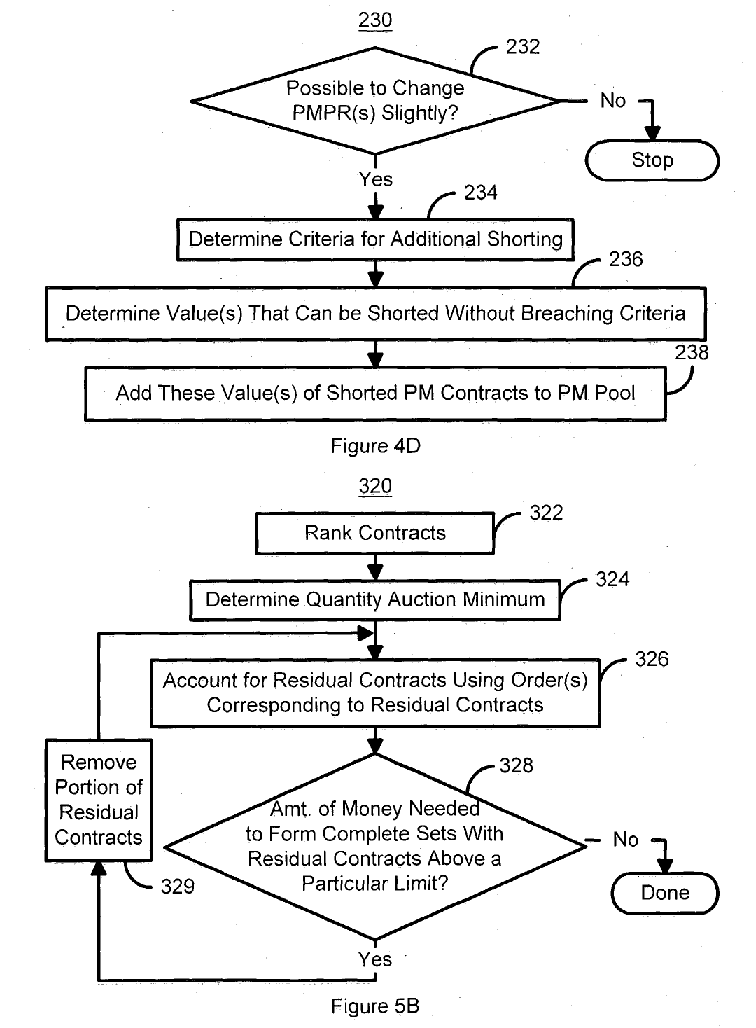

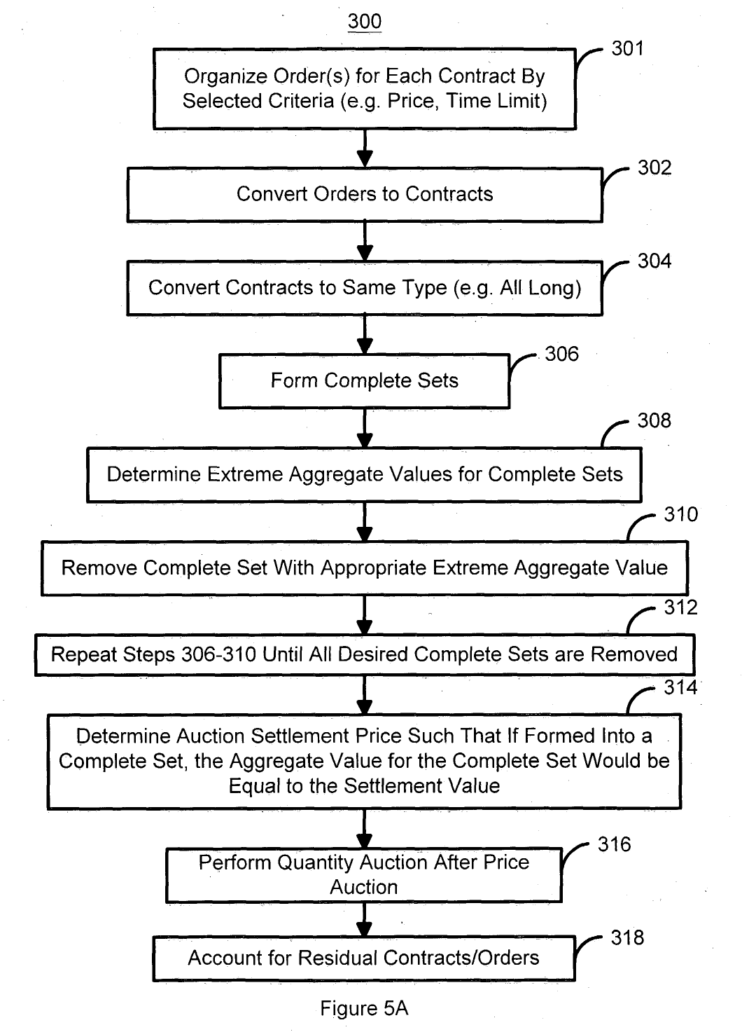

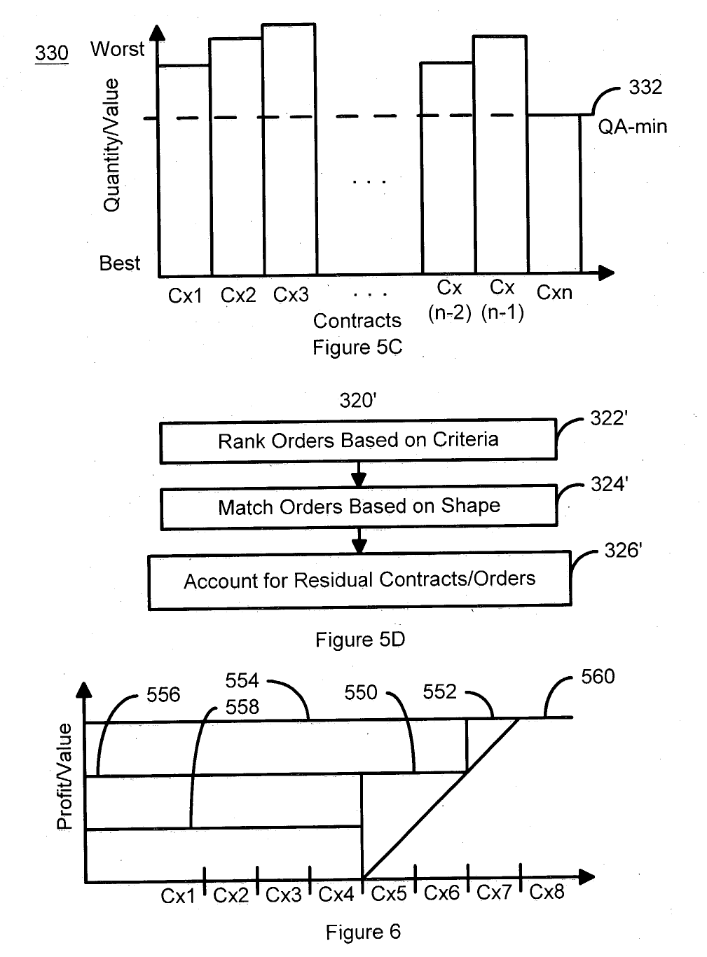

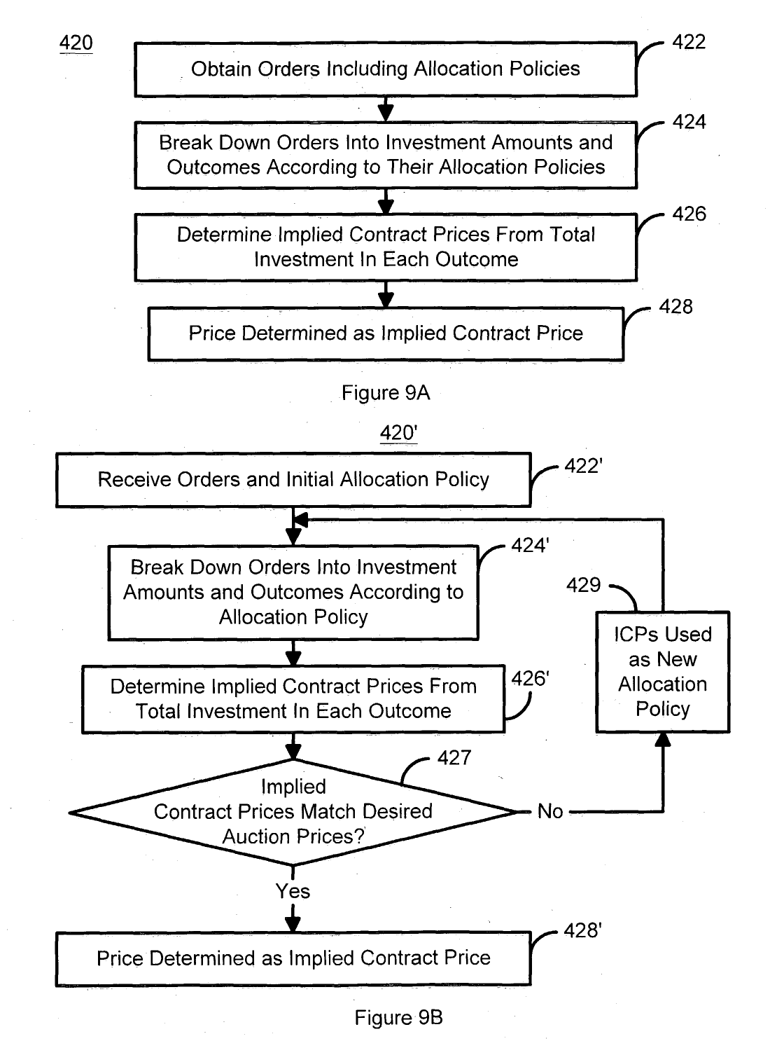

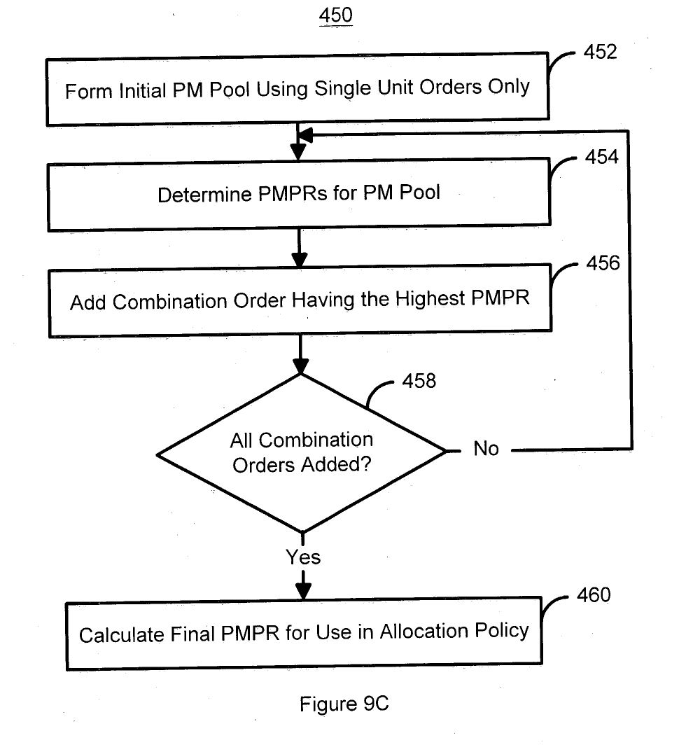

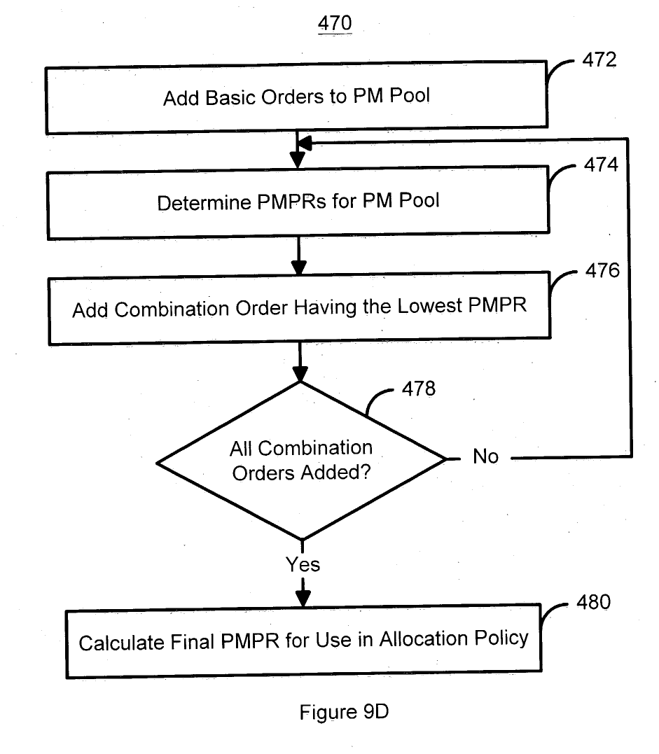

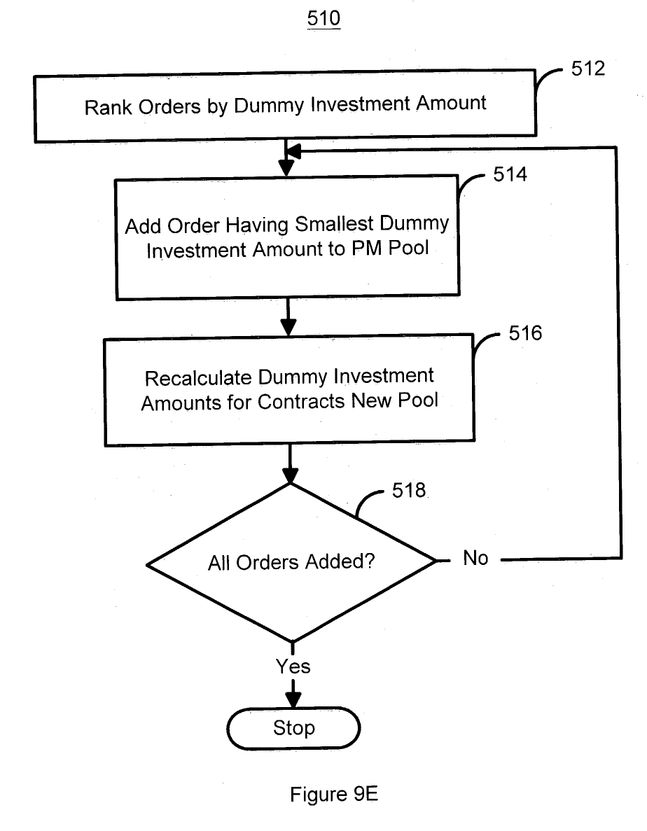

The following methods in FIGS. 4A-9 relate to step 101, 102 and 102′ of the methods 100 and 100′. Similarly, FIGS. 4A-9 relate to the method 150 and 160. In particular, mechanisms for determining the price and quantity for combination orders and noncombination orders are described. A noncombination order is an order in which only a single contract of a particular quantity is in the order. A combination order is an order which combines more than one contract and in which the transaction will take place only if all contracts in the order can be bought or sold. For example, if there are contracts Cx1, Cx2, and Cx3 in a complete set, a combination order could include buying a first quantity of Cx1 and a second quantity of Cx2. For example, the determination of price is described below in the explanation of allocation policy, for example in FIGS. 9A-9E. The determinations of the quantities are described with respect to the quantity auction, for example in FIGS. 5B-5D.

FIG. 4A depicts a high-level flow chart of one embodiment of a method 200 in accordance with the present invention for determining the PM pool for noncombination orders and combination orders. The method 200 preferably concludes before step 102 or 102′ concludes. The method 200 is also used when market participants are only allowed to buy PM contracts or when the dollar investment in long buy orders for one or more PM pool contracts is greater than or equal to the dollar investment in short sell orders for the PM pool contract. The method 200 can also be used when there are price limits for orders for the PM pool contracts in the PM pool. Note that for a PM pool, a price limit corresponds to a PMPR limit. The PM pool is initially formed by all orders, regardless of the price limits, via step 202. The orders initially in step 202 could be contract orders or investable amount orders. Orders (i.e. contract orders) at specific prices and quantities in auctions can be further converted to investable amounts, termed dummy investable amounts, via step204. In order to do so, the quantity of an order is multiplied by the limit price of per contract in the order to obtain the dummy investable amount for each order. For instance, if one wants to buy ten contracts of x1 with the biding price limit of $12, its dummy investable amount in the PM Pool would be 10*$12=$120. Then the PMPR for each outcome, or PM pool contract, is thus determined using this initial PM pool, via step 204. The PMPR can be determined in a conventional manner in step 204.

An implied price for each order can be determined by the PMPR, via step 206. The relationship between the implied price and the implied contract price is given by price for this contract=sum of the price of each single outcome contract in this order and the price of each single outcome contract being settlement value divided by the PMPR for this outcome. With the implied contract price, a percentage difference for each order can also be determined in step 206. The percentage difference is given by (price limit of this order−implied contract price of this order)/implied contract price of this order. This percentage difference is an indicator of the aggressiveness of an order, the more positive the percentage difference, the more aggressive the order. Then, the order with the most negative percentage difference, being the least aggressive, is at least partially removed from the PM Pool via step 208. Thus, a new PM pool is formed in step 208. Steps 204 (determining a new PMPRs) to step 208 (partially removing the order with the most negative percentage difference) are iteratively repeated until all the orders in the PM pool are finalized, via step 210. In a preferred embodiment, step 210 is performed until all remaining long orders in the PM pool are within a certain limit. Consequently, orders not having a price limit remain in the PM pool and orders having a price limit remain in the pool if their price limit has the appropriate relationship with the implied contract price. In addition, note that orders may be partially filled (partially included in the PM pool) when the percentage difference with the implied contract price approaches zero. Moreover, nothing prevents including orders having a negative price differential if desired. Note that after the method 200 is completed, some of the orders may be tested to ensure that the PM pool will function as desired. Once the PM pool is finalized in step 202, the pool is optionally expanded to account for netting of long and short orders, described in FIGS. 4B and 4C, via step 212. How the PM pool is expanded depends upon how long and short orders were accounted for. Thus, the details of step 212 are described below in describing FIGS. 4B and 4C.

In an embodiment of the method 200 in which only long orders (purchases) occur, step 208 discards the order having the largest positive percent difference between the order's price limit and the implied contract price determined using PMPR for the pool. Thus, step 208 would discard the order having the price limit that is less than the corresponding implied contract price by the largest amount. In an embodiment of the method in which there are both long and short orders, then step 208 discards the long order having the largest negative percent difference and the short order having the largest positive percentage difference. Thus, the long order having the price limit less than the corresponding implied contract price by the largest amount and the short order's price limit greater than the corresponding implied contract price by the largest amount are discarded in step 208. In either case, the method 200 iterates through until the orders until the PM pool is finalized. Once the PM pool is finalized, the method 100 or step 102 and above of the 100′ can be applied to convert the PM pool to complete sets of contracts.

FIG. 4B is a high level flow chart of a one embodiment of a method 220 for forming a PM pool when there are price limits, buy and sell orders for the PM pool contracts. The method 220 can also be used when there are price limits for the PM pool contracts in the PM pool. The method 220 is used when the value of long orders is less than the value of short orders for a particular PM contract. Thus, the method 220 is used for determining the initial contracts to be included in the PM pool in step 202 of the method 200. If the method 220 is used, the step 212 would preferably be applied in order to expand the PM pool as described above.

The long orders for the PM contract are added together to form a miniature PM pool for the PM contract, via step 222. Thus, the miniature PM pool has a value equal to the sum of the values for the long orders. It is determined whether one of the short orders can be added to the miniature PM pool without reducing the value of the miniature PM pool below zero, via step 224. Thus, step 224 determines whether a short order can be added to balance the long orders without leaving the miniature PM pool with a net short order. If so, then the short order is added to the miniature PM pool, via step 226. In a preferred embodiment, the short order added has the largest value possible that can be added and still leave the miniature PM pool with the value of the long orders greater than or equal to the value of the short orders. Step 226 thus incrementally adds short orders to long orders for the PM contract. The resulting miniature PM pool has a quantity that is reduced by the value of the short order added in step 226. Step 224 is then returned to. If no short order can be added to the long orders and have the value of the miniature PM pool remain greater than or equal to zero, then no more short orders can be added. Consequently, the remaining short orders are discarded, via step 228. Thus, the (long and short) orders for the particular PM contract to be added to the PM pool in step 202 of the method 200 are determined.

Step 212 expands the pool as described below when the method 220 is used. For example, suppose there are four possible outcomes, and thus four different types of PM contracts: A, B, C, and D. Also suppose that the net number of long orders for A, B, C, and D are $1,000,000; $2,000,000; $3,000,000; and $4,000,000, respectively. Thus, the total value of the PM pool formed is $10,000,000. The PMPR for A, B, C, and D are 10, 5, 3.33, and 2.5, respectively. Also suppose that there are only short orders for A. The value of the long orders for A is $3,000,000, while the value of short orders for A is $2,000,000. Because there is actually a total of $3,000,000 of long orders, the pool is expanded to account for the additional long orders, via step 212. The pool is expanded by implied PMPR. The value of long orders that has been netted is $2,000,000. Given the PMPR above, the value of the netted long orders for A implies values of B, C, and D of $4,000,000; $6,000,000; and $8,000,000, respectively. The final pool would thus include the quantities $3,000,000; $6,000,000; $9,000,000; and $12,000,000 for A, B, C, and D, respectively. The total value of the pool would be $30,000,000 and the PMPR would be unchanged from the PMPR determined when the long and short orders for A were netted.

FIG. 4C is a high level flow chart of a second embodiment of a method 220′ for forming a PM pool when there are price limits, buy and sell orders-for the PM pool contracts. Preferably, either the method 220 or the method 220′ is used, but not both. The method 220′ can also be used when there are price limits for the PM pool contracts in the PM pool. The method 220′ is used when the value of long orders is less than the value of short orders for a particular PM contract. Thus, the method 220′ is used for determining the initial contracts to be included in the PM pool in step 202 of the method 200. In addition, the method 220′ is used to aid in avoiding mis-pricing of PM contracts and to allow long (buy) orders to have priority of short orders. Furthermore, the method 220′ does not affect the PMPRs determined based only on long orders.

The long orders only are used in the steps 202-210 of the method 200 to iteratively determine a PM pool and the corresponding PMPRs, via step 222′. Via step 224′, the value of short orders to be added for each PM contract having short orders is determined based upon the ratios implied by the PMPRs previously determined in step 222′. These short orders are added to the PM pool, via step 226′. The remaining short orders are discarded, via step 228′.

For example, assume that there are four possible outcomes (and thus four types of PM pool contracts): x1, x2, x3, and x4. Suppose that the value of long orders is $400,000; $200,000; $100,000; and $300,000 (for a total of $1,000,000) for x1, x2, x3, and x4, respectively. The corresponding PMPRs determined in step 222′ are 2.5, 5, 10 and 3.33 for x1, x2, x3, and x4, respectively. The percentage of the total investment is forty, twenty, ten, and thirty for x1, x2, x3, and x4 respectively. The short orders can be added based on the percentages of investment for x1, x3, x3, and x4. Suppose that given the values of short orders, those that can be included in the PM pool using step 224′ while preserving the percentages of investment are $40,000; $20,000; $ 10,000; and $30,000, for x1, x2, x3, and x4, respectively.

If the method 220′ is used in netting the short and long investments, then step 212 of the method 200 expands the pool as follows. The short orders are converted into long orders based upon the percentages of each contract. In particular, a short order of x1 corresponds to a long in x2, x3, and x4. A value of $40,000 shorted x1 corresponds to longs of $20,000; $10,000; and $30,000 for x2, x3, and x4, respectively. A value of $20,000 shorted x2 corresponds to longs of $40,000; $10,000; and $30,000 for x1, x3, and x4, respectively. A value of $10,000 shorted x3 corresponds to longs of $40,000; $20,000; and $30,000 for x1, x2, and x4, respectively. A value of $30,000 shorted x4 corresponds to longs of $40,000; $20,000; and $10,000; for x1, x2, and x3, respectively. Thus, a long position of the totals of all of the long positions added for x1, x2, x3, and x4 are, therefore, $120,000; $60,000; $30,000; and $90,000, respectively. The PM pool will be increased by $300,000. This corresponds to (n−1)*(total value of shorted PM contracts determined in step 224′), where n=number of possible outcomes for the PM pool. The final, expanded PM pool would have values of $520,000; $260,000; $130,000; and $390,000 for x1, x2, x3, and x4. However, the PMPR for each would not be changed by expanding the PM pool.

FIG. 4D is a high level flow chart of a third embodiment of a method 230 for forming a PM pool when there are price limits, buy and sell orders, and noncombination orders for the PM pool contracts. The method 230 is termed last mileage shorting. Last mileage shorting is performed only after the method 220 or 220′ is performed. It is determined whether there is additional room for a small change in the PMPRs calculated after the pool has been expanded in step 212 based on the method 220 or 220′, via step 232. If not, then the method 230 terminates. Thus, step 232 determines whether more PM contracts can be shorted. A criterion for the additional shorting is determined, via step 234. For example, step 234 could include determining an allowable percentage difference between the PMPR already calculated and the PMPR that would result from additional shorting. In another embodiment, step 234 could include determining how volume is to be increased using the additional shorting. The additional value(s) that could be shorted without breaching the criteria is determined in step 236. The PM contract(s) shorted up to these value(s) are added to the PM pool, via step 238.

The methods 200, 220, 220′, and 230 can be used in finalizing a PM pool. Once the PM pool has been finalized, the method 100 and/or 100′ and the method 150 can be used to convert the PM contracts to complete sets of contracts. The benefits of at least the first and second co-pending applications can thus be achieved.

Auctions are treated in an analogous manner to PM pools. FIG. 5A depicts one embodiment of a method 300 in accordance with the present invention for finalizing the contracts in an auction. Once the method 300 is completed, the methods 100, 100′ and/or 150 can be used to convert the auction contracts to complete sets of contracts. Alternatively, the method 300 can be considered to perform the step 101 of the method 100′. A complete set (defined in step 102 or 102′) corresponding to auction contracts would preferably include one of each contract in the auction. Orders for each type of contract in the auction are organized by price limit and time chop, via step 301. The Market Order without price limits is assigned a higher rank than those with price limits. Thus, the contracts may be ranked from highest to lowest price for each contract type. Orders of specific investable amount and PMPR limit in auction can be converted to a number of contracts, termed dummy contracts orders, via step 302. In order to do so, the investable amount of an order is multiplied by its PMPR limit (where PMPR limit is equal to the settlement value/price limit) and then divided by its settlement value in the order to obtain the quantity of the dummy contract orders for each order. For instance, if one wants to bid contract Cx1 with $10,000 and a PMPR of 10, its dummy contract order would be (assuming a settlement value of $100) $10,000*(10/$100)=1,000 dummy contracts of x1.

After performing step 302, the contracts are then all converted to the same type, via step 304. Preferably, the short (sell) contracts are converted to long (buy) X contracts, via step 304. However, the long contracts can also be converted to short contracts. For example, a short of a contract would be converted to a long by longing the remaining contracts in the complete set. For example, suppose the auction includes contracts Cx1, Cx2, Cx3, and Cx4. A short of Cx1 would correspond to a long of Cx2, Cx3 and Cx4. For the purposes of discussion, the long of Cx2, Cx3 and Cx4 will be termed C(not x1). Thus, a complete set is Cx1+C(not x1). Complete sets are then formed using the longs and converted shorts and ranked, preferably based upon price, via step 306. In the example above, the complete sets could include Cx1+Cx2+Cx3+Cx4; Cx1+C(not x1); Cx2+C(not x2); Cx3+C(not x3); Cx4+C(not x4); or [C(not x1)+C(not x2)+C(not x3)+C(not x4)]/3. Step 306 is preformed to obtain the complete sets having the highest aggregate value of the complete set for longs and the lowest aggregate value of the complete set for shorts. The most extreme aggregate values possible for the complete sets are then determined, via step 308. The highest aggregate values for longs are determined in step 308, while the lowest aggregate values for shorts are determined in step 308. The most extreme aggregate (highest for buying, lowest for selling) is removed, via step 310. Steps 306-310 are then repeated until the complete sets having an aggregate value greater than/less than the settlement value for long/short orders are removed, via step 312. Referring back to FIG. 5A, the auction settlement price (ASP) for each remaining contract is then determined, via step 314. Thus, step 314 can be considered to be a price auction. The ASP is determined in step 314 based upon the rebasing of the last one or more complete sets of contracts traded and is such that the total value of a complete set according to the ASP for each contract is the settlement value. In particular, the ASP is set such that if formed into a complete set, the aggregate value for the complete set would be equal to the settlement value. For example, if there are three contracts in a complete set Cx1, Cx2, and Cx3 and the last set traded is for an aggregate value of Cx1+Cx2+Cx3=107 (settlement value is 100) for a long, and −Cx1−Cx2−Cx3=97 for a short, (converting the short to a long gives Cx1+C(not x1)=102, Cx2+C(not x2)=104, and Cx3+C(not x3)=101). For the three equations involving Cx1, Cx1 composes seventy, fifty and sixty percent, respectively, of the total value. A price of a remaining Cx1 can be given based on simple average weighting of Cx1=(0.7*107+0.5*97 +0.6*102)/3. The sum of the average weights of Cx1, Cx2, and Cx3, and thus the prices of Cx1, Cx2, and Cx3, are then rebased to be equal to the settlement value (preferably the initial settlement value). Thus, the auction settlement price for each of the contracts is equal to the price of the contract after the complete set has been rebased to the settlement vale.

The process quantity auction, performed in step 316 and described briefly above, is preferably separated from the price auction (which determines the PMPR) and occurs after the price auction. This separation is different from conventional systems. Thus, after the prices are determined in step 314, a quantity auction is performed in step 316. In conventional systems, the number of orders filled is determined together with the prices. In contrast, in the preferred embodiment, the qualified orders (e.g. price limit for buy orders is greater than or equal to the finalized price or the price limit for the sell orders is less than or equal to the finalized price) may not form complete sets. Hence, a quantity auction is preferably implemented to find the order filled if the organizers seek to be risk neutral. The quantity auction of step 316 removes the unqualified orders (buy orders with price limit lower than the finalized price, or vice versa for sell orders) and ranks the remaining orders from best (most aggressive as defined above) to worst (least aggressive-generally best to worst price limit).

The quantity auction performed in step 316 ranks the remaining, qualified, contracts individually from best to worst (typically best price to worst price) The complete sets are formed in step 316 using the best priced contracts to worst price contracts. In other words, one complete set is formed using the best priced single outcome contract of each outcome, then for another complete set using the second best priced single outcome contract of each outcome, and so on. The maximum number of complete sets that can be formed this way is the quantity auction minimum (QA-min). These qualified contracts correspond to complete sets and can be sold by the SPV or other entity. The remaining contracts after the quantity auction is completed do not constitute a complete set, and are thus residual contracts. The quantity auction preferably minimizes the number of residual contracts through the use of the QA-min. For a continuous variable, discussed below, the quantity auction is performed in an analogous manner. Thus, the orders are accumulated in a manner which best fills the interval for the selected in the quantity auction performed in step 316. Thus, the orders are preferably accumulated to minimize residual contracts, or spaces in the interval. The residual contracts and/or orders may then be accounted for, via step 318.

As described above, in one embodiment, the qualified orders will be accumulated in the quantity auction. Thus, a quantity auction may be performed in step 316 of the method 300 depicted in FIG. 5A or step 166 of the method 160 depicted in FIG. 3B.

FIG. 5B depicts a high-level flow chart of one embodiment of a method 320 for performing a quantity auction. The contracts corresponding to the orders are ranked, via step 322. Preferably, the contracts are ranked based on their aggressiveness. A QA-min is determined for the contracts, via step 324. Based on the QA-min, the residual contracts can be determined as those contracts above the QA-min. FIG. 5C depicts such a situation 330 in which the quantity auction is being performed. The contracts Cx1 to Cxn are shown. The best orders for each contract are along the abscissa, while quantity is along the ordinate. The QA-min 332 is, in this case, defined by contract Cxn, which has the lowest quantity. The residual contracts are those which are above the QA-min 332.

The residual contracts are accounted for using the corresponding order(s), via step 326. In one embodiment, some portion of the residual contracts can be removed. In addition, the residual contracts to be removed may be selected based on certain criteria, such as aggressiveness. In an alternate embodiment, orders corresponding to some portion of the residual contracts can be accounted for by forming additional complete set(s) of contracts. For example, the organizer may invest an amount of money to enable some or all of the residual contracts to form complete sets. The organizer may also reduce this investment amount by removing one or more residual contracts.

In particular, step 326 includes determining the amount of money needed to form complete sets with the residual contracts. If this amount is below a particular limit, as determined in step 328, the amount involved in residual orders are considered below a certain limit and this quantity auction is considered performed. If the amount of money needed to form complete sets with the residual contracts is above the particular limit, as determined in step 328, some portion of the residual contracts would be removed, via step 329. The residual contracts removed are selected based on one or more selection criteria. These criteria may be, but are not limited to, contracts' aggressiveness, time chop and size. In the process of removing residual contracts, once one contract is removed, other contracts in the same combinational order may also need to be removed. Thus, step 329 includes removal of orders corresponding to residual contracts. After a portion of the residual contract is removed, steps 326to 329 are iterated repeated until the amount of money needed to form complete sets with the residual contracts is below a particular limit. What remains is a number of complete set(s) of contracts and (removed) residual contracts. Consequently, the quantity auction is performed.

FIG. 5D is a high-level flow chart of an alternate embodiment of a method 320′ for performing a quantity auction using shape matching of the orders. In general, the method 320′ attempts to form complete sets by matching a more aggressive order with other aggressive orders to attempt to form complete sets in priority of aggressiveness. The orders are ranked based on certain criteria, via step 322′. In a preferred embodiment, the orders are ranked based upon their aggressiveness. The orders are matched one by one and based on their shape, in order to form complete sets, via step 324′. The orders having a higher priority (e.g. aggressiveness) are matched. Because orders may have different shapes, (e.g. a call and a put at different strike prices, call spreads and put spreads at different strike prices and payouts), the matching step 324′ is performed. The matching step 324′ preferably continues until no orders could form additional complete sets without an additional investment. Any residual contracts left after the matching step 324′ has been performed are accounted for, via step 326′. Thus, the methods 320 and 320′ can be used to perform quantity auctions, thereby determining the quantities of contracts.

As described above, the combination orders may introduce residual contracts. There are actually two possibilities for combination orders. They may be uniform quantities (UQ) or nonuniform quantities (NUQ). A UQ occurs when an order has the same quantity for each contract in the order. For example, a bid for one Cx1 and one Cx2 (out of a complete set including Cx1, Cx2, and Cx3) is an example of a UQ order. An NUQ may be one Cx1 and four Cx2. The methods 320 and 320′ may be capable of handling the UQ situation. For example, a quantity auction may be able to be performed on UQ combination orders easily by matching their strikes. However, when there are NUQ orders, ranking and shape matching becomes more difficult.

In addition to method 320 and 320′, a quantity auction performed on continuous variables (NUQ) having combination orders may result in residual contracts. Such a situation is depicted in FIG. 6. FIG. 6 depicts residual contracts 550 and 552 after a quantity auction is performed for a particular continuous variable. The digital puts 554, 556, and 558 and the call spread 560 have been accumulated. Thus, the residual contracts 550 and 552 remain. In a preferred embodiment, the orders 554, 556, 558 and 560 minimize the residual contracts 550 and 552.

As discussed above in FIGS. 5A, 5B, and 5D, the residual contracts and/or orders are accounted for in steps 318, 326, and 326′. Some portion (including all) of the residual contracts and/or residual contracts, termed the net residual, could be kept by the SPV for the next auction. Some portion (including all) of the net residual could be auctioned out, for example using the ASP. Some portion (including all) of the net residual could be discounted for the auction. Any losses from doing so might be distributed to the successful orders. Moreover, the discount at which the net residual is sold at could be iteratively determined. For example, in order to auction out the net residual, a new settlement value, SV′, may be determined based upon the original settlement value SV. In such a case, the new settlement value might be given by:

SV′=SV+(Σ net residual contracts)*(100−x)/(N−n)

where:

x=recovery rate

=100 if the net residual is auctioned at the ASP

n=number of complete sets formed by net residual contracts

N=number of complete sets in quantity auction (Σ net residual contracts)*(100−x)=total proceeds from auction of net residual

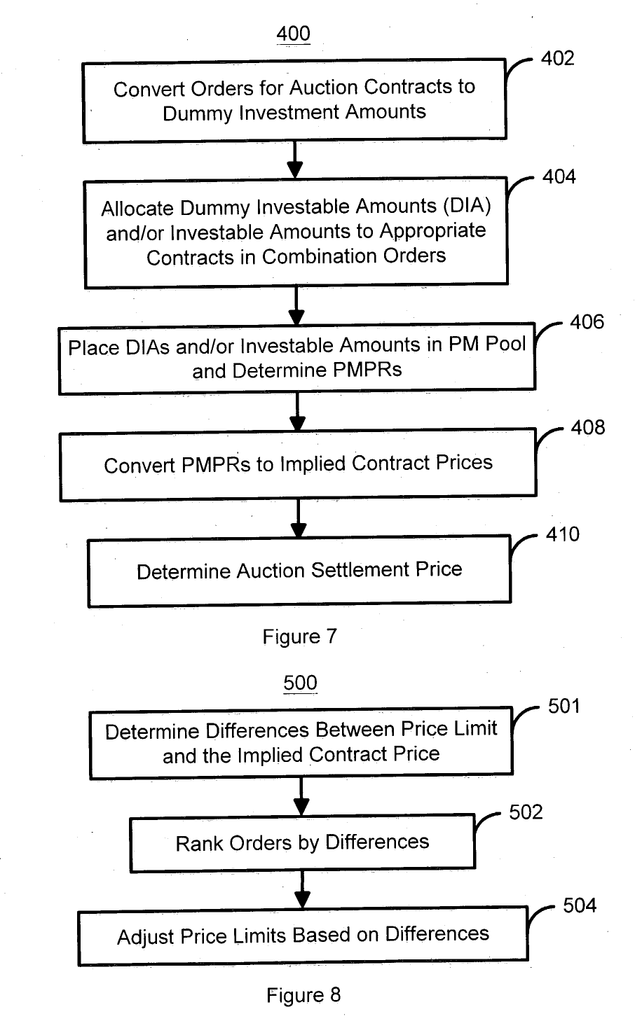

FIG. 7 depicts a high level flow chart of a method 400 for the treating orders, particularly combination orders in an auction. Orders at specific prices and quantities in auctions can be converted to amounts, termed dummy investable amounts, via step 402. In order to do so, the quantity of an order is multiplied by the limit price of per contract in the order to obtain the dummy investable amount for each order. For instance, if one wants to buy 10 contracts of x1 with the biding price limit of $12, its dummy investable amount in the PM Pool would be 10*$12=$120. Alternatively, step 402 can be skipped for orders that are already expressed in terms of investable amounts. The dummy investable amounts and/or investable amounts are then allocated to the appropriate contracts, via step 404. The dummy investable amounts and/or investable amounts are allocated because for combination orders, the price limit for the order is for the combination. Consequently, it may not be clear how much of the investable amount/dummy investable amount should correspond to which contract in the combination order. Thus, the investable amounts/dummy investable amounts are allocated between contracts according to an allocation policy, described below. The investable amounts/dummy investable amounts are then treated as orders in a PM pool, via step 406. The methods 200, 220, 220′ and 230 above can then be applied. The PMPRs found in step 406 are then converted back to contract prices (termed implied contract prices) based upon the PMPR and quantities, via step 408. The ASP can then be determined based upon the implied contract prices, via step 410. The method 400 thus takes the place of step 314 in the method 300, above. The quantity auction can then be performed based on the ASP in step 316 of the method above. Thus, a price auction has effectively taken place and the price determined in the method 400.

In addition to method 400, FIG. 8 depicts a preferred embodiment of a method 500 for providing a better estimation of contract orders in term of dummy investable amount used in step 406. This method 500 could also be a performing step in step 206 that allows contract orders. This method 500 would enhance the modeling of the contract order into investable amount. A PM pool has already formed initially based on the (dummy) investable amounts (which are calculated via step 402), the initial PMPRs have been calculated and the initial implied contract prices have been determined when the method 500 commences. The relative differences between the price limit and the implied contract price are determined, via step 501. Note that the relative differences can be positive (price limit greater than implied contract price for buy orders) or negative (price limit less than implied contract price for sell orders). The orders are ranked based on the relative differences, via step 502. In one embodiment, the ranking goes from the largest positive difference at one end to the largest negative difference at another end. The price limit(s) are then adjusted based on the ranking of the percentage differences, via step 504. In the following example, method 200 is used for determining the PMPR (in step 406). In step 208 of method 200, orders are removed from the pool if they are not aggressive enough. In addition to using step 208 to deal with contract orders, the most aggressive contract orders may have their price limit adjusted to obtain a better approximation of their “true” investable amount. If the buy order having the largest percentage differences has a positive percentage difference, the price limit can be adjusted down by a desired amount using the method 500. In one embodiment, the most aggressive order could reduce its price limit so that it is no longer the most aggressive. Once the method 500 is completed, each of the contract orders will have a better estimation of the corresponding dummy investable amount. The PMPRs can be determined better in every iteration of the price determining step 406.

In order to treat combination orders in price auction, allocation policies used in step 404 are determined. An allocation policy is a method to determine the splitting of an investable amount of a combination order into different contracts. Allocation could be dynamic (e.g. exact allocation) or static (predetermined allocation). In combinational orders, an allocation policy is essential for investment allocating in individual contract. For static allocation policies, one may allow a market participant unfettered discretion in allocating the dummy investable amount between the contracts in the order. However, this allocation policy makes it possible for a market participant to manipulate the outcome. As a result, the allocation policy or policies, such as those used in step 404, should not allow the market participant unfettered discretion in selecting how the dummy investable amount is allocated. In one embodiment, another allocation policy could be selected. For example, the investable amount could be allocated evenly between the contracts in the order. In another embodiment, the choices of the market participant should be restricted or be preselected by the organizer. For example, a reputable agent could select the available alternatives for allocating investable amounts. Allocation policies that allow a market participant to select how investable amounts are to be allocated (within certain limits) are generally referred to herein as static allocation policies.

FIG. 9A depicts a flow chart of one embodiment of a method 420 for allocating investable amounts using a static allocation policy. In the static allocation method 420, market participants are allowed to indicate their allocation policy or policies, preferably within certain limits as described above. The orders including the corresponding allocation policies are taken, via step 422. The orders are broken down to their investment amounts for each PM pool contract in the order and the corresponding outcomes for the PM pool contracts in the order, via step 424. In order to do so, step 424 utilizes the allocation policies selected by the market participants. Thus, the investable amounts in each PM pool contract for each order are determined in step 424. The implied contract prices are determined based upon the total investable amount in each PM pool contract, via step 426. The prices of the contracts in the complete set are then set as the implied contract prices, via step 428.

Thus, using the static allocation method 420, market participants can specify the allocation between the PM pool contracts in their orders. The prices are then determined based upon these allocations. However, note that the allocation policies and, therefore, final prices may generally be decided by market makers. Market makers are market participants that typically deal in very large volumes and a large number of orders.

For example, suppose that the orders for PM contracts X1, X2, X3, and X4 are shown in Table 1

TABLE 1

| | | |
|---|---|---|
| Order 1: | Buying $10000 on X1 and X2 | Allocation policy 1:1:1:1 |
| Order 2: | Buying $10000 on X2 and X3 | Allocation policy 1:3:1:1 |
| Order 3: | Buying $10000 on X3 and X4 | Allocation policy 1:1:2:1 |
| Order 4: | Buying $10000 on X4 and Xl | Allocation policy 2:3:2:3 |

Consequently, the corresponding investment allocation determined in step 424 is shown in Table 2.

TABLE 2

| | X1 | X2 | X3 | X4 |
|---|---|---|---|---|
| Order 1 | $5000 | $5000 | | |
| Order 2 | | $7500 | $2500 | |
| Order 3 | | | $6666.67 | $3333.33 |
| Order 4 | $4000 | | | $6000 |
| Total | $9000 | $12500 | $9166.67 | $9333.33 |

The total amount invested is $40,000. The implied contract prices are determined in step 426 using the investment amounts and a desired settlement value (sum of the prices of contracts for X1, X2, X3, and X4 of $100). Thus, the implied contract prices for X1, X2, X3, and X4 are determined in step 426 as $22.5, $31.25, $22.92 and $23.33 respectively. Thus, the method 420 can be used to allow market participants to select their allocation.

Although static allocation policy can be used, in a preferred embodiment, an exact allocation policy is used in step 404. An exact allocation policy has the benefits that it is not readily manipulated by market participants, tends to converge to a stable equilibrium and can reward orders already made in the marketplace based upon selected criteria, such as price limit, time, or size.

FIG. 9B is a high-level flow chart of one embodiment of a method 420′ using dynamic allocation policy. To be more specific, this is actually an exact allocation policy. Preferably, the final allocation policy achieved using the method 420 matches the ratios of the prices determined using the method. The orders and an initial, organizer-selected allocation policy are taken, via step 422′. The orders are broken down to their investment amounts for each PM pool contract in the order and the corresponding outcomes for the PM pool contracts in the order, via step 424′. In order to do so, step 424 utilizes the initial allocation policies selected by the organizer. Thus, the investable amounts in each PM pool contract for each order are determined in step 424′. The implied contract prices are determined based upon the total investable amount in each PM pool contract, via step 426′. It is determined whether the implied contract prices determined in step 426′ match the desired auction prices, via step 427. If so, the prices of the contracts in the complete set are set as the implied contract prices, via step 428′. Otherwise the implied contract prices determined in step 426′ are used for the (new) allocation policy, via step 429. Thus, in step 429 the ratios between the implied contract prices can be used to determine how investable amounts are to be allocated between the contracts. Step 424′ is then returned to. The method 420′ then iterates until the desired implied contract prices are achieved. Thus, using the method 420′, the organizer may allocate investable amounts in a manner which matches the marketplace.

For example, assume that the method 420′ is applied to the PM contracts (X1, X2, X3, and X4) of the previous example. Consequently, the orders are shown in Table 3

TABLE 3

| | |
|---|---|
| Order 1: | Buying $10000 on X1 and X2 |
| Order 2: | Buying $10000 on X2 and X3 |
| Order 3: | Buying $10000 on X3 and X4 |
| Order 4: | Buying $10000 on X4 and X1 |

The initial allocation policy (preferably selected by the organizer), for X1, X2, X3, X4 is 1:1:1:1. Consequently, the investment allocation determined in step 424′ are shown in Table 4.

TABLE 4

| | X1 | X2 | X3 | X4 |
|---|---|---|---|---|
| Order 1 | $5000 | $5000 | | |
| Order 2 | | $5000 | $5000 | |
| Order 3 | | | $5000 | $5000 |
| Order 4 | $5000 | | | $5000 |
| Total | $10000 | $10000 | $10000 | $10000 |

The resulting implied contract prices (assuming a settlement value of $100) determined in step 426′ for X1, X2, X3, X4 are $25, $25, $25, $25, respectively. Because the ratios of the implied contract prices match the ratios of the allocation policy (1:1:1:1), the method 420′ need not iterate further. Consequently, the prices for X1, X2, X3, and X4 are set as $25, $25, $25, and $25, respectively. Thus, in the method 420′ an initial guess to the allocation policy is used in step 422′. Using the implied prices as the new allocation policy in step 429, the method 420′ iterates until a converging solution is found.

There are a number of ways in which the dynamic allocation policy, such as the one used in step 404 and described in the methods 420 and 420′, can actually be implemented. The organizer of the auction could choose to implement one or more of the dynamic allocation policies. The dynamic allocation policy could be a base case allocation policy based upon the PMPR ratios or contract prices found prior to the price auction. For example suppose the PMPR of two contracts, A and B, in the complete set are 4x and 5x, respectively. Thus, the dummy investable amount is allocated between A and B in a 5:4 ratio.

Alternatively, the allocation policy could be iteratively determined based upon the market, or PMPRs. FIG. 9C depicts one embodiment of a method 450 for determining the market based allocation policy based upon the highest single unit PMPR. An initial PM pool is formed using only the single unit orders, via step 452. The PMPRs are calculated based upon the current (initial) PM pool, via step 454. The combination order corresponding to the highest PMPR (lowest contract price) is added to the PM pool, via step 456. If there is more than one combination order corresponding to the highest PMPR, the order having the earlier time chop will be added. It is determined whether all combination orders have been added, via step 458. If not, step 454 is returned to in order to obtain a new PMPR. Steps 454 through 458 are thus repeated. If all combination orders have been added, then the final PMPR for the allocation policy is calculated, via step 460. The PMPRs can then be used in the dynamic allocation policy in step 404. In particular, the PMPRs can be used to allocate the dummy investable amounts between the contracts in NUQ combination orders.

In an alternate embodiment, the dynamic allocation policy is based upon the lowest PMPR. FIG. 9D depicts one embodiment of a method 470 for determining the market based allocation policy based upon the lowest single unit PMPR. Basic orders are added to the PM pool, via step 472. The PMPR is calculated, via step 474. The order having the lowest PMPR is added to the PM pool, via step 476. It is determined whether all of the orders have been added, via step 478. If not, then step 474 is returned to in order to recalculate the PMPR. Steps 474 through 478 are repeated until all of the orders are included in the PM pool. When all of the orders, combination and otherwise, are included, a final PMPR is calculated, via step 480. This PMPR can then be used for determining how to allocate the dummy investable amounts and/or investable amounts in step 404 in the method 400 above. The method 470 allows the lower PMPR orders to be added more rapidly. Consequently, aggressive/high price (low PMPR) orders are included more rapidly and, therefore, rewarded.

FIG. 9E depicts one embodiment of a method 510 for determining the dynamic allocation policy based upon the dummy investable amounts and/or investable amounts. The dummy investable amounts and/or investable amounts are presumed to already have been calculated. Thus, the orders are ranked by dummy investable amount and/or investable amounts, via step 512. The order having the smallest dummy investable amount and/or smallest investable amount is added to the pool, via step 514. The dummy investable amounts and/or investable amounts for the contracts in the pool are then calculated, via step 516. It is determined whether all orders have been added, via step 518. If not, then step 512 is returned to. Otherwise, the method terminates. The final total investable amounts (including the dummy investable amount) for each contract in the complete set are used to determine how to allocate between contracts in the complete set. Although the method 510 functions, it may be subject to manipulation. Consequently, the method 510 may be adjusted.

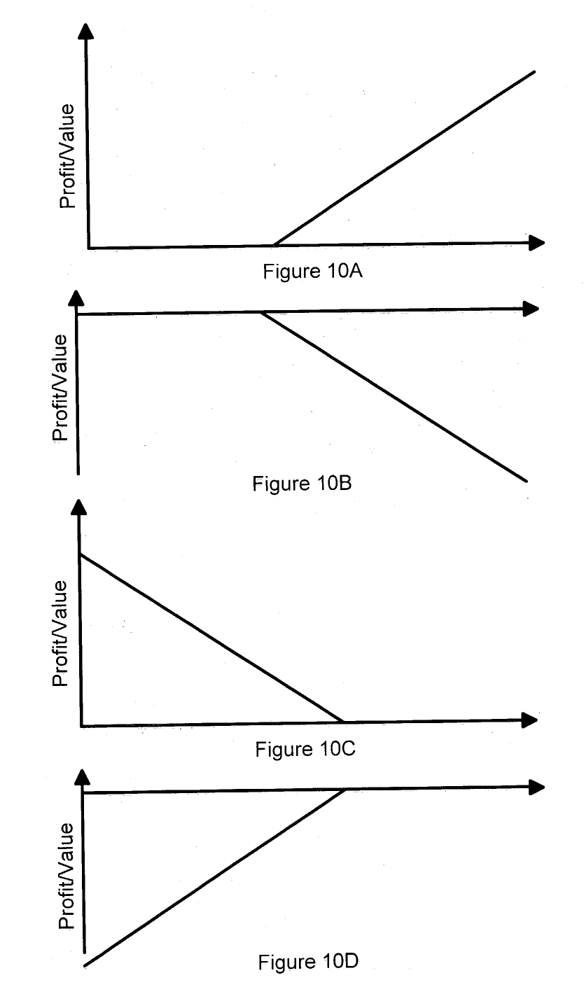

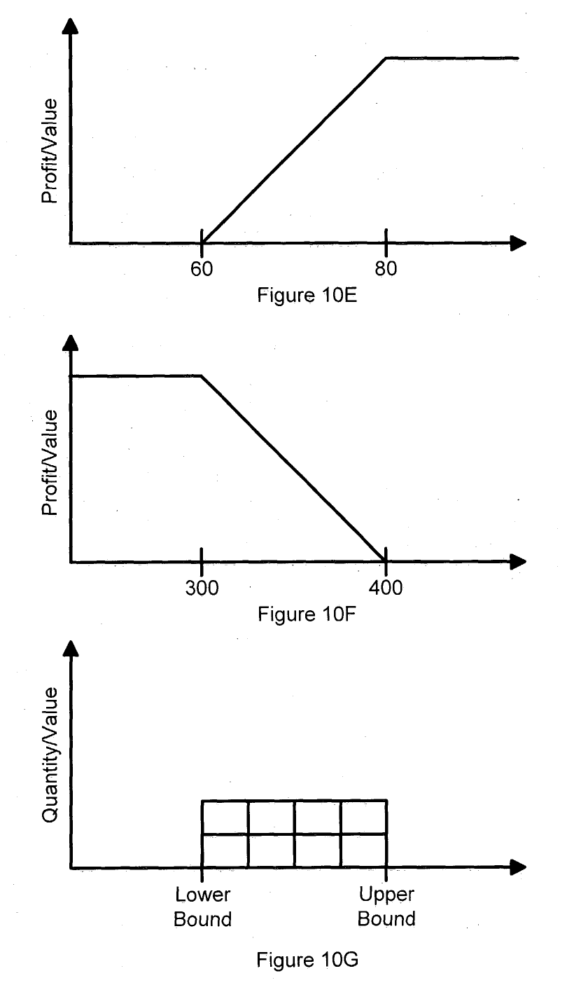

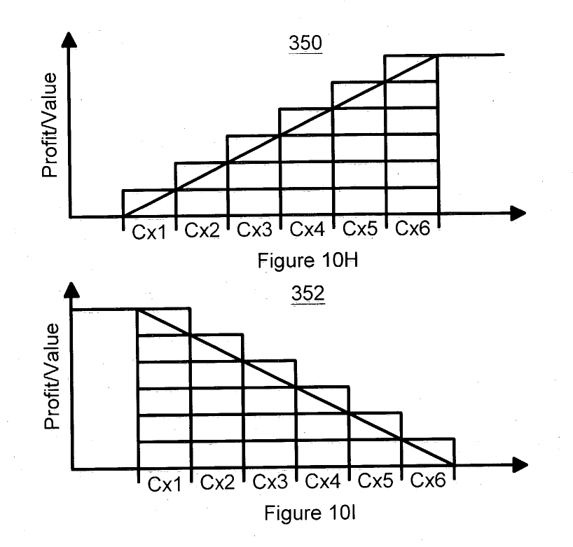

As mentioned before, the combination orders could be uniform quantities (UQ) or non-uniform quantities (NUQ). An uniform quantity order would be something like a digital call/put, while a NUQ quantity order would be something like a call/put spread. Although the NUQ quantity orders do not need to be continuous, they actually do in a natural demand. An example of an NUQ for a continuous variable is a stock. In such a case, the return for the stock increases as the price of the stock increases. In addition, the return in the NUQ case has a slope that is either diverging (return increases as the stock price increases) or converging (return decreases as the price of the stock increases). Diverging slope (DS) can be considered as a long/short for a call above the defined strike price (FIG. 10A and FIG. 10B) while converging slope (CS) can be considered as a long/short for a put above the defined strike price (FIG. 10C and FIG. 10D). The return for the long/short call below the strike price is zero. Similarly, the return for the long/short put above the strike price is zero. In general, a long call has a positive increasing return above the strike price, while a short call has a negative increasing return above the strike price. Similarly, a long put has a positive decreasing return below the strike price, while a short put has a negative increasing return below the strike price. FIGS. 10A, 10B, 10C, and 10D are graphs depicting the return for a long call, a short call, a long put, and a short put respectively. Furthermore, a spread provides a return over a range of the variable. FIGS. 10E and 10F depict a call spread between sixty and eighty and a put spread between three hundred and four hundred, respectively.

Ideally, orders should be able to be represented by a set of basic units in order to perform price auction in step 164 of method 160 (Preferably, the basic unit is one in which the notional cost of the contract is equivalent to the tick value of the corresponding continuous variable.). This could be easily done when there are only UQ orders. This is because UQ orders may easily represent by basic units (as shown in FIG. 10G). However, this is less clear for NUQ order with a continuous variable. For a call spread in FIG. 10H, the order may be represented by basic units of: one of Cx1, two of Cx2, three of Cx3, four of Cx4, five of Cx5 and six of Cx6. Although the price auction may still function with the NUQ orders represented by basic units (FIGS. 10H and 10I), one of ordinary skill in the art will readily recognize that put and call spreads are actually diagonal lines. In a preferred embodiment, a diagonal allocation policy is used. A basic unit is converted into a CS basic unit and a DS basic unit, where CS and DS basic unit are continuous variable. Consequently, these basic units would then be triangular instead of rectangular and hence they are termed DS and CS diagonal basic units, respectively. Thus, a put spread and a call spread can be represented by DS or CS basic units. These DS and CS basic units can still be used in the allocation policy, described above.

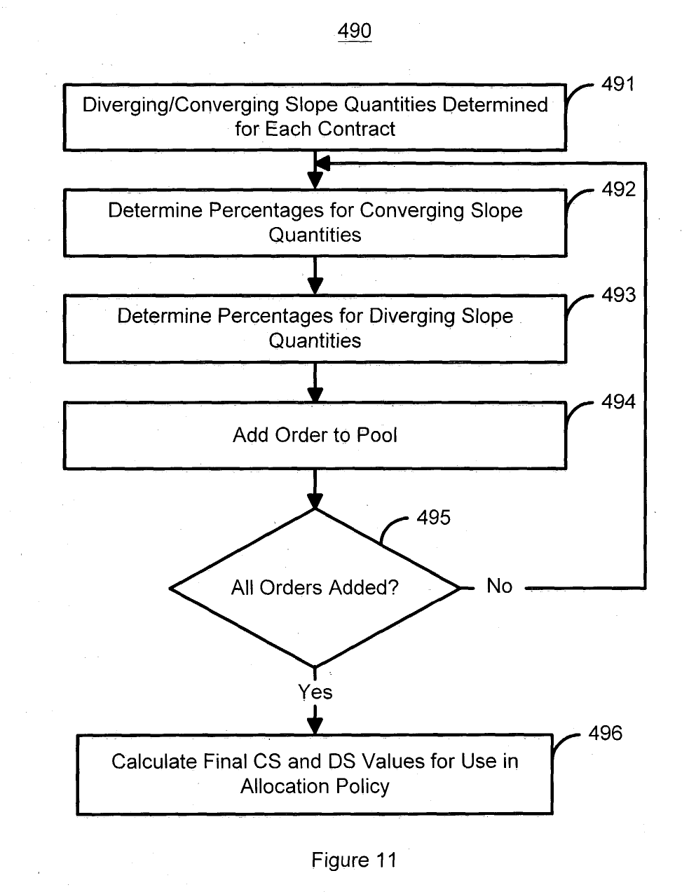

In the preferred embodiment, the basic unit A is split into A-CS and A-DS, where A-CS and A-DS sum to A. In order to determine the price of the triangle, A-CS and A-DS is treated as two base units and perform the price determination to find their corresponding prices. In one embodiment, such as the embodiment of a diagonal allocation policy depicted in FIG. 11, the quantities of DS and CS can be used for weighting. To do so, all orders are collected and the quantities and the portion/percentage corresponding to CS and DS for each contract could then be determined, via steps 491, 492, and 493. This could be done after a basic unit price determination step. In the example above, suppose that A, A-CS and A-DS have quantities Q1, Q2, and Q3 in the orders. The percentages of CS for the contracts are determined based on the quantities in step 492. In the example above, the percentage of A-CS is given by (Q1+Q2)/(2*Q1+Q2+Q3). The percentages of DS for the contracts are also determined based upon quantities in step 493. In the example above, the percentage of A-DS is given by (Q1+Q3)/(2*Q1+Q2+Q3). Another order, if any, is added to the pool, via step 494. It is determined whether all orders have been added, via step 495. If not, then step 492 is returned to and the method 490 repeated. Otherwise, the CS and DS percentages for the contracts are determined for a final time based upon the quantities, via step 496. These final CS and DS for the combination orders are used to determine how to allocate the dummy investable amounts. With the two above embodiments, the contract price of contracts that involve continuous variable, such as call, put, call spread and put spread, can be determined.

According to the system and method disclosed herein, the present invention provides improved liquidity, improves the management of credit related risks and allows greater flexibility in transactions related to PM pools and auctions. The PMPRs and ASPs can be determined for the contracts. In addition, PMPR and ASPs can be iteratively determined to select the desired orders for inclusion in the PM pool or auction. Once finalized, the PM contracts or auction contracts in the PM pool or auction can be converted into complete sets of contracts. The contracts in the complete sets of contracts can be sold, or bought, by the organizer and/or SPV. Consequently, at least some of the benefits of the first and second co-pending applications can be achieved. For example, liquidity can be improved.

A method and system has been disclosed for improving the liquidity of transactions particularly for PM pools and auctions. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for improving liquidity of transactions for a first plurality of contracts for a pari-mutuel (PM) pool or an auction, the method comprising the steps of:
providing a complete set including a second plurality of contracts corresponding to the first plurality of contracts, the complete set guaranteeing at least an initial settlement value at at least one particular time, the complete set corresponding to a settlement value, the settlement value being determined based upon the initial settlement value.

2. The method of claim 1 wherein the settlement value is determined based on the initial settlement value and an interest rate effect, if necessary, wherein the interest rate effect includes an adjustment in a present value based upon an interest rate, the initial settlement value, and a time between the at least one particular time and the settlement value being determined.

3. The method of claim 1 wherein each of the plurality of contracts matures upon at least one particular event occurring and wherein the complete set corresponds to at least the settlement value regardless of whether the at least one particular event occurs for any of the plurality of contracts.

4. The method of claim 1 wherein the providing step further includes the step of:
converting the first plurality of contracts to the second plurality of contracts.

5. The method of claim 4 wherein the first plurality of contracts are for a PM pool, wherein the settlement value corresponds to a value of the PM pool, and wherein the converting step further includes the steps of:
determining a PM payoff ratio (PMPR) for each of the first plurality of contracts; and
determining a first quantity and first price of each of the second plurality of contracts corresponding to one of the first plurality of contracts utilizing the PMPR ratio for each of the first plurality of contracts, a notional for each of the first plurality of contracts and a held quantity for each of a plurality of market participants holding a portion of the first plurality of contracts.

6. The method of claim 5 wherein a portion of the first plurality of contracts are divided contracts.

7. The method of claim 1 further comprising the step of:
iteratively determining the first plurality of contracts for the PM pool or auction.

8. The method of claim 7 wherein the iteratively determining step further includes the steps of:
forming an initial PM pool using a plurality of orders, a portion of the plurality of orders having a plurality of price limits;
determining a PMPR ratio and thus Implied Contract Price for each of the first plurality of contracts;
comparing the plurality of price limits against the implied contract price for a portion of the first plurality of contracts corresponding to the portion of the plurality of orders, thereby producing a plurality of price differentials;
at least partially removing an order of the plurality of orders from the initial PM pool having a largest price differential of the plurality of price differentials.

9. The method of claim 8 wherein the iteratively determining step further includes the steps of:
repeating the determining, comparing and at least partially removing steps until a desired PM pool is achieved; and
optionally expand the desired PM pool to account for netting of at least one short order and at least one long order.

10. The method of claim 7 wherein the iteratively determining step further includes the steps of:
netting at least one short order and at least one long order.

11. The method of claim 10 wherein the netting step further includes the steps of:
forming a miniature PM pool using only the at least one long order;
determining whether one of the at least one short order can be added to the miniature PM pool without reducing the miniature PM pool below zero; and
adding one of the at least one short order to the miniature PM pool if it is determined that the one of the at least one short order can be added without reducing the miniature PM pool below zero.

12. The method of claim 10 wherein the netting step further includes the steps of:
obtaining at least one PMPR for a miniature PM pool including the at least one long order;
determining at least one value for the at least one short order based upon the at least one PMPR;
adding the at least one value for the at least one short order to the miniature PM pool.

13. The method of claim 10 wherein the netting step further includes the steps of:
performing last mileage shorting.

14. The method of claim 5 wherein the iteratively determining step further includes the steps of:
organizing a plurality of orders based upon at least one criterion;
converting the plurality of orders to a first order type;
forming a plurality of complete sets;
determining a plurality of extreme aggregate values for the plurality of complete sets;
removing one of the plurality of complete sets having a desired aggregate value;
repeating the complete set forming, extreme aggregate value determining and removing steps until a desired portion of the plurality of complete sets is removed;
determining at least one auction settlement price;
performing a quantity auction; and
accounting for any net residual.

15. The method of claim 8 wherein the plurality of orders include at least one combination order having at least one value and wherein the method further includes the steps of:
determining at least one dummy investable amount (DIA) for a portion of the plurality of orders;
allocating the at least one value for each of the at least one combination order;
forming a second PM pool based upon the at least one DIA;
providing at least one PMPR for the second PM pool; and
converting the at least one PMPR to at least one implied contract price.

16. The method of claim 8 wherein the plurality of orders include at least one combination order having at least one value and wherein the method further includes the steps of:
forming an initial PM pool using at least one single unit order of the plurality of orders;
determining at least one initial PMPR for the initial PM pool;
adding a portion of the at least one combination order having a highest initial PMPR;
repeating the forming, determining and adding steps as required to account for all of the at least one combination order;
calculating at least one final PMPR; and
using the at least one final PMPR in allocating the at least one value for each of the at least one combination order.

17. The method of claim 8 wherein the plurality of orders include at least one combination order having at least one value and wherein the method further includes the steps of:
forming an initial PM pool using at least one basic order;
determining at least one initial PMPR for the initial PM pool;
adding a portion of the at least one combination order corresponding to a lowest initial PMPR of the at least one initial PMPR;
iteratively repeating the forming, determining and adding step until each of the at least one combination order is accounted for; and
using the at least one initial PMPR in allocating the at least one value for each of the at least one combination order after each of the at least one combination order is accounted for.

18. The method of claim 8 wherein the plurality of orders include at least one combination order having at least one value, wherein the plurality of orders are based on at least one continuous variable, and wherein the method further includes the steps of:
using a diagonal allocation policy for allocating the at least one value for each of the at least one combination order after each of the at least one combination order is accounted for.

19. The method of claim 8 wherein the plurality of orders include at least one combination order having at least one value, wherein the plurality of orders are based on at least one continuous variable, wherein a portion of the plurality of orders include at least one price limit, and wherein the method further includes the steps of:
providing at least one dummy investable amount based on the at least one price limit; and
adjusting the at least one price limit based on differences between the settlement value and the at least one price limit.

20. The method of claim 1 further comprising the steps of:
providing a special purpose vehicle;
allowing a special purpose vehicle to buy and/or sell at least a portion of a complete set.

21. The method of claim 20 wherein the allowing step further includes the step of:
allowing the special purpose vehicle to assemble the complete set by purchasing at least the portion of the complete set based upon a sum of offers and the settlement value.

22. The method of claim 21 wherein the allowing step further includes the step of:
automatically purchasing the at least the portion of the complete set to assemble the complete set when a sum of offers for the complete set is less than or equal to the settlement value.

23. The method of claim 20 wherein the allowing step further includes the step of:
allowing the special purpose vehicle to sell the at least the portion of the complete set based upon a sum of bids and the settlement value.

24. The method of claim 20 wherein the allowing step further includes the step of:
automatically selling the at least the portion of the complete set to at least one market participant using the special purpose vehicle when a sum of bids for the complete set is greater than or equal to the settlement value.

25. The method of claim 20 wherein the special purpose vehicle is allowed to secure trades when buying and/or selling at least one of the second plurality of contracts.

26. The method of claim 1 wherein at least one bid to buy corresponds to at least one contract of the second plurality of contracts and wherein the allowing step further includes the step of:
generating a conditional order to sell a remaining portion of the complete set, the conditional order to sell being based upon the at least one bid, the conditional order having a corresponding condition, the corresponding condition being the at least one bid and the conditional order to sell both being accepted, the special purpose vehicle making at least one trade of the remaining portion of the complete set when the condition is fulfilled.

27. The method of claim 26 wherein a sum of the at least one bid and a total of at least one price for each of the remaining contracts is less than or equal to the settlement value.

28. The method of claim of 27 wherein the generating step further includes the step of:
generating a zero price bid to provide the at least one bid.

29. The method of claim 20 wherein at least one offer to sell corresponds to at least one contract of the second plurality of contracts and wherein the allowing step further includes the step of:
generating a conditional order to buy a remaining portion of the complete set, the conditional order to buy being based upon the at least one offer, the conditional order having a corresponding condition, the corresponding condition being the at least one offer and the conditional order both being accepted, the special purpose vehicle making at least one trade of the remaining portion of the complete set when the condition is fulfilled.

30. The method of claim 29 wherein a sum of the at least one offer and a total of at least one price for each of the remaining contracts is greater than or equal to the settlement value.

31. The method of claim 20 wherein at least the special purpose vehicle is provided using a computer system.

32. The method of claim 20 wherein a plurality of market participants correspond to at least a portion of the second plurality of contracts, the method further comprising the steps of:
determining a credit risk for each of the plurality of market participants based upon the settlement value and a selling price for each of the second plurality of contracts.

33. The method of claim 32 wherein a portion of the plurality of market participants are short selling a first portion of the second plurality of contracts, and wherein the credit risk determining step further includes the steps of:
determining the credit risk for each of the portion of the plurality of market participants based upon the selling price of each of the first portion of the second plurality of contracts and a winning payout for the contract.

34. The method of claim 33 wherein the credit risk is the winning payout minus the selling price.

35. The method of claim 34 wherein an exchange acts as a custodian for a short margin for each of the plurality of market participants, the short margin being based upon the credit risk.

36. The method of claim 34 wherein the special purpose vehicle acts as a custodian for a short margin for each of the plurality of market participants, the short margin being based upon the credit risk.

37. The method of claim 36 wherein the special purpose vehicle places the short margin in an interest bearing account.

38. A method for improving liquidity of transactions for a plurality of contracts for a pari-mutuel (PM) pool or an auction, the method comprising the steps of:
obtaining a plurality of orders corresponding to the plurality of contracts;
performing a price auction on the plurality of orders in order to determine a plurality of contract prices for the plurality of orders;
performing a quantity auction, after the price auction, to determine a quantity of the plurality of orders which are qualified.

39. The method of claim 38 further comprising the step of:
accounting for a plurality of residual contracts, if any.

40. A computer-readable medium containing a program for improving liquidity of transactions for a first plurality of contracts for a pari-mutuel (PM) pool or an auction, the program including instructions for:
providing a complete set including a second plurality of contracts corresponding to the first plurality of contracts, the complete set guaranteeing at least an initial settlement value at at least one particular time, the complete set corresponding to a settlement value, the settlement value being determined based upon the initial settlement value.

41. The computer-readable medium of claim 40 wherein the settlement value is determined based on the initial settlement value and an interest rate effect, if necessary, wherein the interest rate effect includes an adjustment in a present value based upon an interest rate, the initial settlement value, and a time between the at least one particular time and the settlement value being determined.

42. The computer-readable medium of claim 40 wherein the providing instructions further includes instructions for:
converting the first plurality of contracts to the second plurality of contracts.

43. The computer-readable medium of claim 42 wherein the first plurality of contracts are for a PM pool, wherein the settlement value corresponds to a value of the PM pool, and wherein the converting instructions further include instructions for:
determining a PM payoff ratio (PMPR) for each of the first plurality of contracts; and
determining a first quantity and first price of each of the second plurality of contracts corresponding to one of the first plurality of contracts utilizing the PMPR ratio for each of the first plurality of contracts, a notional for each of the first plurality of contracts and a held quantity for each of a plurality of market participants holding a portion of the first plurality of contracts.

44. The computer-readable medium of claim 40 wherein a portion of the first plurality of contracts are divided contracts.

45. A computer-readable medium containing a program for improving liquidity of transactions for a plurality of contracts for a pari-mutuel (PM) pool or an auction, the program including instructions for:
obtaining a plurality of orders corresponding to the plurality of contracts;
performing a price auction on the plurality of orders in order to determine a plurality of contract prices for the plurality of orders;
performing a quantity auction after the price auction to determine a quantity of the plurality of orders which are qualified.

46. The computer-readable medium of claim 45 wherein the program includes instructions for:
accounting for a plurality of residual contracts, if any.

47. A system for improving liquidity of transactions for a first plurality of contracts for a pari-mutuel (PM) pool or an auction, the system comprising:
means for providing a complete set including a second plurality of contracts corresponding to the plurality of contracts, the complete set guaranteeing at least an initial settlement value at at least one particular time, the complete set corresponding to a settlement value, the settlement value being determined based upon the initial settlement value.

48. The system of claim 47 wherein the settlement value is determined based on the initial settlement value and an interest rate effect, if necessary, wherein the interest rate effect includes an adjustment in a present value based upon an interest rate, the initial settlement value, and a time between the at least one particular time and the settlement value being determined.

49. The system of claim 47 wherein each of the plurality of contracts matures upon at least one particular event occurring and wherein the complete set corresponds to at least the settlement value regardless of whether the at least one particular event occurs for any of the plurality of contracts.

50. The system of claim 47wherein the providing means further includes:
means for converting the first plurality of contracts to the second plurality of contracts.

51. The system of claim 50 wherein the first plurality of contracts are for a PM pool, wherein the settlement value corresponds to a value of the PM pool, and wherein the converting means further includes:
means for determining a PM payoff ratio (PMPR) and thus Implied Contract Price for each of the first plurality of contracts; and
means for determining a first quantity and first price of each of the second plurality of contracts corresponding to one of the first plurality of contracts utilizing the PMPR ratio for each of the first plurality of contracts, a notional for each of the first plurality of contracts and a held quantity for each of a plurality of market participants holding a portion of the first plurality of contracts.

52. The system of claim 50 wherein a portion of the first plurality of contracts are divided contracts.

53. The system of claim 50 further comprising:
means for iteratively determining the first plurality of contracts for the PM pool or auction.

54. The system of claim 53 wherein the iteratively determining means further includes:
means for forming an initial PM pool using a plurality of orders, a portion of the plurality of orders having a plurality of price limits;
means for determining a PMPR ratio for each of the first plurality of contracts;
means for comparing the plurality of price limits against the plurality of Implied Contract Prices for a portion of the first plurality of contracts corresponding to the portion of the plurality of orders, thereby producing a plurality of price differentials;
means for at least partially removing an order of the plurality of orders from the initial PM pool having a largest price differential of the plurality of price differentials.

55. The system of claim 50 wherein the system further includes:
a special purpose vehicle;
allowing a special purpose vehicle to buy and/or sell at least a portion of a complete set.

56. A system for improving liquidity of transactions for a plurality of contracts for a pari-mutuel (PM) pool or an auction, the system comprising:
means for obtaining a plurality of orders corresponding to the plurality of contracts;
means for performing a price auction on the plurality of orders in order to determine a plurality of contract prices for the plurality of orders; and
means for performing a quantity auction to determine a quantity of the plurality of orders which are qualified.

57. The system of claim 56 wherein the program includes instructions for:
accounting for a plurality of residual, contracts, if any.
